(19) United States
(12) Patent Application Publication
(10) Pub. No.: US 2002/0176149 A1
(43) Pub. Date: Nov. 28, 2002

(54) Variable optical source

(76) Inventors: Michael Davis, Glastonbury, CT (US); Alan D. Kersey, South Glastonbury, CT (US); John Moon, Wallingford, CT (US); James Dunphy, South Glastonbury, CT (US); James Sirkis, Wallingford, CT (US); Joseph Pinto, Wallingford, CT (US); Paul Szczepanek, Middletown, CT (US)

Correspondence Address: CiDRA Corporation, 50 Barnes Park North, Wallingford, CT, 06492, US

(21) Appl. No.: 10/115,648

(22) Filed: Apr. 3, 2002

Related U.S. Application Data
(60) Provisional application No. 60/281,079, filed on Apr. 3, 2001.
(60) Provisional application No. 60/311,002, filed on Aug. 8, 2001.
(60) Provisional application No. 60/365,682, filed on Mar. 18, 2002.
(60) Provisional application No. 60/365,446, filed on Mar. 18, 2002.
(60) Provisional application No. 60/365,741, filed on Mar. 18, 2002.
(60) Provisional application No. 60/365,461, filed on Mar. 18, 2002.

(51) Int. Cl. G02B 26/00

(52) U.S. Cl. 359/290; 359/291; 359/292

(57) ABSTRACT

A variable optical source 801 to selectively provide a desired optical output signal in response to a control signal is provided. The optical source includes an optical filter that attenuates a broadband optical input signal or a multi-spectral input signal 802. The optical filter is controllable or programmable to selectively provide a desired filter function. The optical filter 10 includes a spatial light modulator 36, which may comprise an array of micromirrors 52 that effectively forms a two-dimensional diffraction grating mounted in a retro-reflecting configuration. The input optical signal is dispersed onto the array of micro-mirrors 52 along a spectral axis or direction 55 such that input light is spread over a plurality of micromirrors to effectively pixelate the light. The broadband light or signals of the multi-spectral input light is selectively attenuated by flipping or tilting a selected number of micromirrors to thereby deflect a portion of the incident radiation away from the return optical path. The micro-mirrors operate in a digital manner by flipping between a first and second position in response to a control signal 56 provided by a controller 58 in accordance with an attenuation algorithm and an input command 60.

### CROSS REFERENCES TO RELATED APPLICATIONS

This application claims the benefit of U.S. Provisional Application No. 60/281,079, filed Apr. 3, 2001; U.S. Provisional Application No. 60/311,002, filed Aug. 8, 2001; U.S. Provisional Application No. 60/365,682, filed Mar. 18, 2002; U.S. Provisional Application No. 60/365,446, filed Mar. 18, 2002; U.S. Provisional Application No. 60/365,741, filed Mar. 18, 2002; and U.S. Provisional Application No. 60/365,461, filed Mar. 18, 2002, all of which are incorporated herein by reference in their entirety.

### TECHNICAL FIELD

The present invention relates to optical sources, and more particularly to variable optical sources including a spatial light modulator, such as an array of micro-mirrors to selectively shape or attenuate a broadband or channelized optical input signal to provide a desire optical output signal.

### BACKGROUND ART

It is known in the field of electronics to provide a variable electronic power supply or source for generating an electrical signal having a desired signal profile. These variable electronic source are uses in a number of test and measurement applications such as trouble shooting systems, measuring operational parameters of a system, and developing new products.

In the field of optics a comparable variable optical source is desirable for the same reasons stated above. Currently, optical sources for test and measurement application comprise a laser or plurality of lasers that may be individually tuned to provide the desired optical output signal, which is expensive and time-consuming to generate the desire output signal. It is therefore desirable to provide a variable optical source that can easily and inexpensively provide a desired optical output signal using a broadband optical source and/or a multi-spectral optical source.

### SUMMARY OF THE INVENTION

An object of the present invention is to provide a variable optical source having a spatial light modulator, wherein the spatial light modulator pixelates the spectrum of the optical signal, to thereby permit shaping or attenuating a broadband or channelized optical input signal for providing a desired output signal.

In accordance with an embodiment of the present invention, a variable optical source, includes a light dispersive element which receives an optical input signal having various wavelength channels of light, which provides a separated light signal having said wavelength channels spatially distributed by a predetermined amount; a pixellating device, which receives said separated light, having a two dimensional array of pixels, each of said channels being incident on a plurality of pixels, each of said pixels having a first reflection state and a second reflection state in response to a pixel control signal, and said pixellating device providing a reflected separated light signal indicative of light provided from said first reflection state; a light combining element, which receives said reflected separated light, recombines said reflected separated light, and provides an optical filter output signal indicative of a spectrally filtered optical input signal based on a filter function; and a controller which generates said pixel control signal indicative of said filter function and wherein said filter function is selectable based on a desired spectral filter profile.

### BRIEF DESCRIPTION OF THE DRAWINGS

FIG. 1 is a block diagram of an optical filter including a spatial light modulator in accordance with the present invention;

FIG. 2 is a block diagram of a spatial light modulator of the optical filter of FIG. 1 having a micro-mirror device, wherein the optical channels of a WDM input light are substantially dispersed onto the micro-mirror device, in accordance with the present invention;

FIG. 3 shows a pictorial view of a partial row of micro-mirrors of the micro-mirror device of FIG. 2 in accordance with the present invention;

FIG. 4 is a plan view of a micro-mirror of the micro-mirror device of FIG. 2 in accordance with the present invention;

FIG. 5 is a plot of an input optical signal having 50 GHz spacing;

FIG. 6 is a plot of the power of the optical channels imaged onto the micro-mirror device, wherein the optical channels of a WDM input light are substantially dispersed onto the micro-mirror device as shown in FIG. 2, in accordance with the present invention;

FIG. 7 is a graphical representation of a transmission filter function of an optical filter, wherein the optical channels of a WDM input light are substantially dispersed onto the micro-mirror device as shown in FIG. 2, in accordance with the present invention;

FIG. 8 is a plot of attenuation curve when a single channel is dropped from the optical input signal of the optical filter of FIG. 2;

FIGS. 9a-c are block diagrams of a spatial light modulator of another embodiment of an optical filter having a micro-mirror device, wherein the optical channels of a WDM input light are overlappingly dispersed onto the micro-mirror device in various degrees of overlap, in accordance with the present invention;

FIG. 10 is an expanded pictorial representation of an illuminated portion of the micro-mirror device of FIG. 9a, that shows the intensity distribution for three overlapping optical channels of the WDM input light, in accordance with the present invention;

FIG. 11 is a graphical representation of a transmission filter function of an optical filter, wherein the optical channels of a WDM input light are overlappingly dispersed onto the micro-mirror device as shown in FIG. 6, in accordance with the present invention;

FIG. 12a is a block diagram of the spectral plane in partial illustration of another embodiment of an optical filter including a spatial light modulator in accordance with the present invention;

FIG. 12b is a block diagram of the spatial plane of the embodiment of the optical filter of FIG. 9a;

FIG. 13 is a block diagram of a closed-loop DGEF system in accordance with the present invention;

FIG. 14 is a perspective view of a portion of a known micro-mirror device;

FIG. 15 is a plan view of a micro-mirror of the micro-mirror device of FIG. 14;

FIG. 16 is a pictorial cross-sectional view of the micro-mirror device of the spatial light modulator of FIG. 14 disposed at a predetermined angle in accordance with the present invention;

FIG. 17 is a pictorial cross-sectional view of the micro-mirror device of the spatial light modulator of FIG. 14 disposed at a predetermined angle in accordance with the present invention;

FIG. 18 is a graphical representation of the micro-mirror device of FIG. 17 in accordance with the present invention;

FIG. 19a is a graphical representation of a portion of the optical filter wherein the grating order causes the shorter wavelengths of light to image onto the micromirror device that is closer than the section illuminated by the longer wavelengths, in accordance with the present invention;

FIG. 19b is a graphical representation of a portion of the optical filter wherein the grating order causes the longer wavelengths of light to image onto the micromirror device that is closer than the section illuminated by the shorter wavelengths, in accordance with the present invention;

FIG. 20 is a block diagram of another embodiment of an optical filter including a spatial light modulator in accordance with the present invention;

FIG. 21 is a block diagram of the micro-mirror device of FIG. 14 having a micro-mirror device, wherein the optical channels of a WDM input light are substantially dispersed onto the micro-mirror device, in accordance with the present invention;

FIG. 22 is a plot showing the commanded gain profile and the resulting gain profile of an optical filter in accordance with the present invention;

FIG. 23 is a plot showing the error the commanded gain profile and the resulting gain profile of an optical filter of FIG. 22;

FIG. 24 is a plot showing the commanded gain profile and the resulting gain profile of an optical filter in accordance with the present invention;

FIG. 25 is a plot showing the error the commanded gain profile and the resulting gain profile of an optical filter of FIG. 24;

FIG. 26 is a plot showing a WDM input signal having a plurality of unequalized optical channels provided to a closed-loop DGEF system in accordance with the present invention;

FIG. 27 is a plot showing the equalized output signal of the closed-loop DGEF system having an input signal shown in FIG. 26;

FIG. 28 is a graphical representation of the light of an optical channel reflecting off a spatial light modulator, wherein the light is focused relatively tight, in accordance with the present invention;

FIG. 29 is a graphical representation of the light of an optical channel reflecting off a spatial light modulator, wherein the light is focused relatively loose compared to that shown in FIG. 28, in accordance with the present invention;

FIG. 30 is a block diagram of another embodiment of an optical filter including a spatial light modulator in accordance with the present invention;

FIG. 31 is an elemental illustration of the optical filter of FIG. 1 in accordance with the present invention;

FIG. 32 is a perspective illustration of an embodiment of an optical filter in accordance with the present invention;

FIG. 33 is an alternative perspective view of the optical filter of FIG. 32;

FIG. 34 is a perspective illustration of an embodiment of a beam generation module (BGM) in accordance with the present invention;

FIG. 35 is an alternative perspective view of the beam generation module of FIG. 34;

FIG. 36 is a perspective illustration of an embodiment of a curved mirror mount in accordance with the present invention;

FIG. 37 is a perspective illustration of an embodiment of a diffraction grating mount in accordance with the present invention;

FIG. 38 is an alternative perspective view of the diffraction grating mount of FIG. 37;

FIG. 39 is a perspective illustration of an embodiment of a turning mirror mount in accordance with the present invention;

FIG. 40 is a perspective illustration of an embodiment of an optical filter including a DMD chip and board assembly in accordance with the present invention;

FIG. 41 is an alternative perspective view of the optical filter of FIG. 37;

FIG. 42 is a perspective view of the optical components of another embodiment of an optical filter embodying the present invention;

FIG. 43 is a simplified side elevation view of a collimating lens and spatial light modulator of an optical filter, in accordance with the present invention;

FIG. 44 is a simplified side elevation view of a collimating lens and spatial light modulator assembly of an optical filter, in accordance with the present invention;

FIG. 45 is a perspective view of the chisel prism of the optical filter of FIG. 42;

FIG. 46 is a top plan view of the optical channel filter of FIG. 39;

FIG. 47 is side elevational view of a portion of the optical channel filter of FIG. 46;

FIG. 48 is an illustration of the optical channel layout on the micromirror device in accordance with the present invention;

FIG. 49 is a plot of the intensity of the optical channels taken across the micromirror device of FIG. 46 along line 46-46;

FIG. 50 is a graphical representation of the retro-reflection of the input light when the micro-mirrors flip about an axis perpendicular to the spectral axis;

FIG. 51 is a graphical representation of the retro-reflection of the input light when the micro-mirrors flip about an axis parallel to the spectral axis;

FIG. 52 is a plot comparing the power loss of the retro-reflected input signal versus wavelength, when the micromirrors flip about the axis parallel to the spectral axis and when the micro-mirrors flip about the axis perdendicular to the spectral axis;

FIG. 53 is a plot comparing the power loss of the retro-reflected input signal versus wavelength, when the micromirrors flip about the axis parallel to the spectral axis and when the micro-mirrors flip about the axis perdendicular to the spectral axis;

FIG. 54 is a perspective view an optical filter device similar to that shown in FIG. 42 in accordance with the present invention;

FIG. 55 is a perspective view of the optical chassis of the optical filter of FIG. 54;

FIG. 56 is a perspective view of the Fourier lens and mount of the optical filter of FIG. 54;

FIG. 57 is an exploded view perspective view of Fourier lens and mount of the optical filter of FIG. 54;

FIG. 58 is perspective view of a portion of the optical filter of FIG. 54;

FIG. 59 is an exploded perspective view of a grating mount of the optical filter of FIG. 54;

FIG. 60 is an exploded perspective view of the grating mount of FIG. 59;

FIG. 61 is a perspective view of a telescope of the optical filter of FIG. 47;

FIG. 62 is an exploded perspective view of the telescope of FIG. 54;

FIG. 63 is a perspective view of a collimating lens of FIG. 54;

FIG. 64 is a block diagram of a spatial light modulator of an optical filter that includes a plurality of optical filters, wherein the optical channels are distinctly projected onto the micromirror device, in accordance with the present invention.

FIG. 65 is a block diagram of an embodiment of the optical filter functioning as a dynamic gain equalization filter in accordance with the present invention;

FIG. 66 is a block diagram of an embodiment of the optical filter functioning as a drop filter in accordance with the present invention;

FIG. 67 is a block diagram of an embodiment of the optical filter functioning as an optical spectral analyzer in accordance with the present invention;

FIG. 68 is a block diagram of an embodiment of the optical filter functioning as a reconfigurable optical add/drop multiplexer in accordance with the present invention;

FIG. 69 is a block diagram of an embodiment of the optical filter functioning as an optical deinterleaver/interleaver device in accordance with the present invention;

FIG. 70 is a block diagram of an embodiment of the optical filter functioning as a variable optical filter in accordance with the present invention;

FIG. 71 is a block diagram of an embodiment of the optical filter functioning as a variable optical filter in accordance with the present invention;

FIG. 72 is a block diagram of an embodiment of the optical filter functioning as a variable optical filter in accordance with the present invention;

FIG. 73 is a block diagram of a variable optical source in accordance with the present invention;

FIG. 74 is a block diagram of a test set-up for determining the cross-talk of a device under test including a variable optical source in accordance with the present invention;

FIG. 75 is a block diagram of a test set-up for measuring the dynamic range of a device under test including a variable optical source in accordance with the present invention;

FIG. 76 is a block diagram of a test set-up for determining the immunity to broadband noise of a device under test including a variable optical source in accordance with the present invention; and

FIG. 77 is a block diagram of the electronics of the DGEF of FIG. 54 in accordance with the present invention.

### BEST MODE FOR CARRYING OUT THE INVENTION

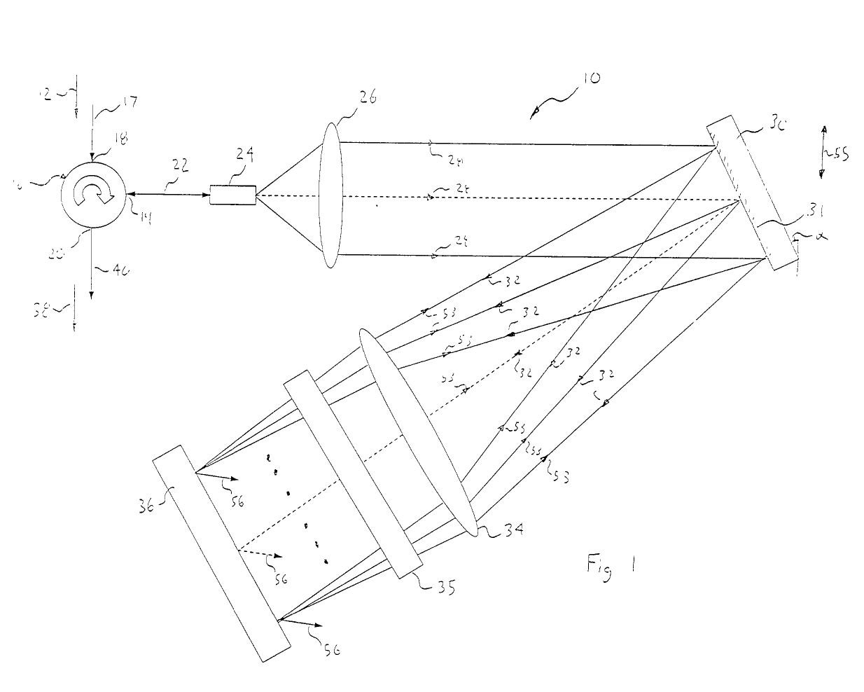

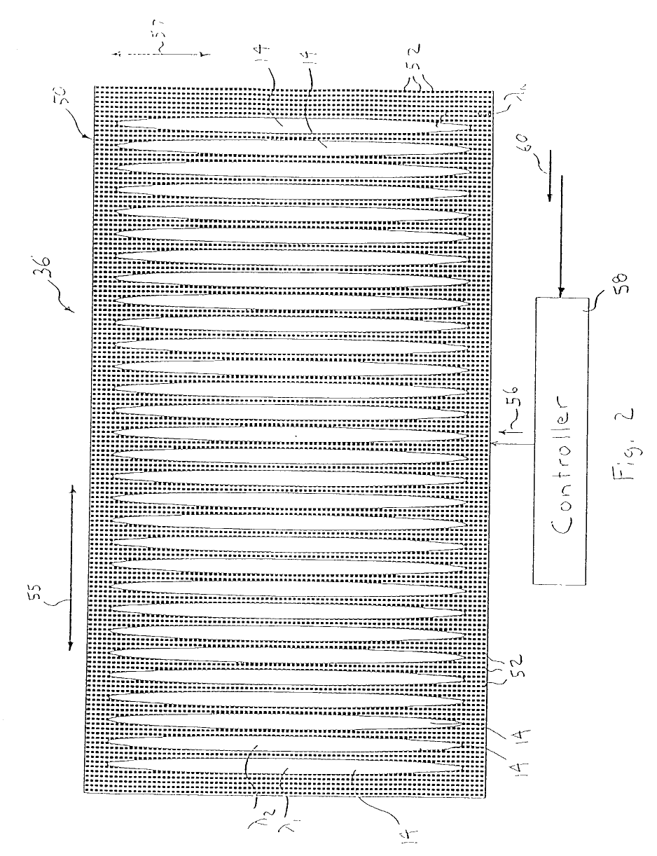

As shown in FIGS. 1 and 2, an optical filter, generally shown as 10, selectively attenuates or filters a wavelength band(s) of light (i.e., optical channel(s)) or a group(s) of wavelength bands of an optical WDM input signal 12 in response to a control signal. Each of the optical channels 14 (see FIG. 2) of the input signal 12 is centered at a respective channel wavelength (λ₁,λ₂,λ₃, . . . λ_{N}) The optical filter is controllable or programmable to selectively provide a desired filter function, which will be described in greater detail hereinafter. The control signal may be provided directly by a user from a control panel or by a processor that is programmed to provide a control signal of a desired output signal. The capability of selectively varying the filter function enables the optical filter to operate as a variable optical source, as shown in FIGS. 73-76.

In FIG. 73, an optical source 800 provides a broadband input signal to the input of an optical filter 10 similar to that shown in FIGS. 1, 2 and 9a to provide a variable optical source 801. As will be described in greater detail hereinafter, the input signal 802 is spread spectrally over a spatial light modulator 36 comprising a plurality of micromirrors 52 of a micromirror device 50 to effectively pixelate the input signal. The micromirrors are then flipped between a first and second position to provide the desire input light to the output fiber or reflect a portion of the light away from the output fiber to selectively attenuate the input signal.

A variety of broadband sources 800 can be used ranging from the ASE of a pumped Er+ system to an LED. In addition, due to the flexibility of the spatial light modulator 36, wavelengths ranging from the visible to the infrared can be used with appropriate devices. The broadband source is intended to provide light covering the entire range of interest, permitting the optical filter 10 the maximum flexibility in producing variable optical outputs.

As shown in FIG. 73, the spatial light modulator 36 of the optical filter 10 may be controlled by a control signal 60 or internally programmed to provide a variety of optical filter functions to produce a corresponding number of spectral source profiles or output signals. For instance, the micromirrors 50 of the spatial light modulator 36 may be flipped to provide a full broadband source at 804, possibly altered to flatten and provide uniform illumination, or other shapes such as a Gaussian shape. Second, the optical filter may be configured to output a subset of the broadband input, exploiting the variable passband features of the micromirror device 50. Third, the optical filter may be configured to output a narrow bandwidth optical signal, which can be static or scanned over the spectral region of interest. Third, the optical filter may be configured to output multi-spectral components, which may be equally spaced set of signals to form a comb, or different arbitrary located signals.

It will be appreciated that the variable optical source is useful for testing of optical networks and components. By providing such a flexible solution, parameters such as wavelength dependence, dynamic range, optical noise floor dependence, optical crosstalk and many others can be tested using a source such as the one described here.

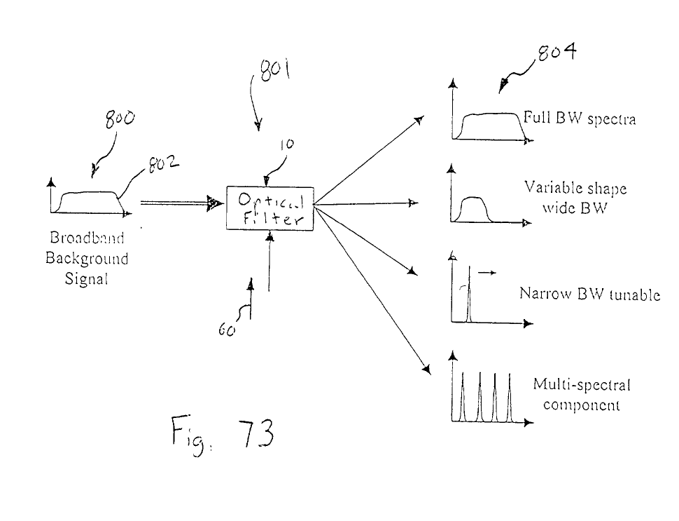

While the optical variable source has been described as having a broadband input source, the present invention contemplates a input source that provides a multi-spectral (or channelized) input source as shown in FIGS. 74-76. Such a variable optical source is useful in various sectors of the test and measurement field such as installation and maintenance of equipment, manufacturing test, and research and development. Throughout each of these sectors similar type of tests may be run for various purposes, ranging from an initial installation of a network to the development work for a next generation system. Some of these tests include cross-talk testing, broadband noise immunity test, and dynamic range testing.

In FIG., 74, for example, a test set-up using the variable optical filter 10 for testing for crosstalk sensitivity in a device under test (DUT) 810 is shown. The ability of the optical filter 10 of the variable source 801 to precisely attenuate or block one or more channels in a DWDM system, which will be described in greater detail hereinafter, permits the testing of systems or components. The optical filter 10, in response to a control signal 60, selectively attenuates and blocks the input channels 14 of the multi-spectral input to provide an output signal 812 that includes a primary signal and one or more secondary crosstalk test signals. When the output signal is injected into the device under test 810 (DUT) the effects of the crosstalk signals can be evaluated. Each of the primary and secondary signal powers and wavelengths can be adjusted to permit complete characterization of the DUT.

In FIG. 75, a test set-up using the variable optical filter 10 for testing the dynamic range of a DUT 810. One important characteristic of some optical test equipment (the DUT) is its ability to resolve both a weak and strong optical signals in close proximity to each other. This specification typically should remain constant of their entire wavelength range of the device. The optical filter functions similarly as that described hereinbefore in FIG. 74. The optical filter 10, in response to a control signal 60, selectively attenuates and blocks the input channels 14 of the multi-spectral input 802 to provide an output signal 812 that includes a primary signal and a small adjacent signal.

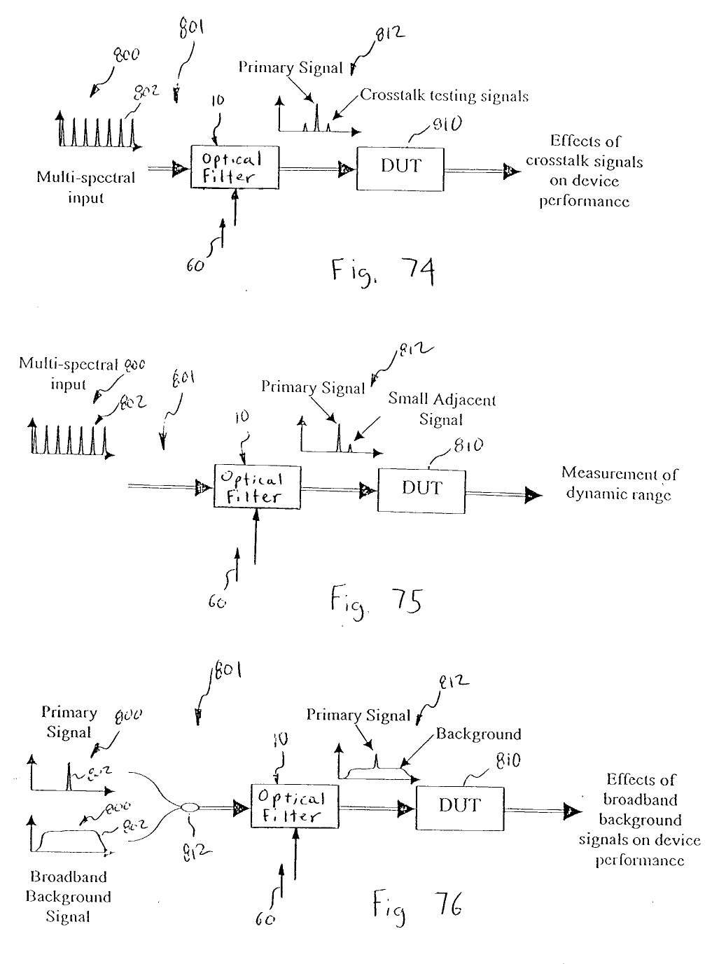

In FIG. 76, a test set-up using the variable optical filter 10 for testing for broadband noise immunity of a system or optical component (i.e., DUT). The variable optical source 801 can test a DUT's susceptibility to background noise present in the incoming optical signal. The variable source can test these characteristics in a DUT 810 with the flexibility of incrementing the level and bandwidth of the background noise signal versus the primary optical channel.

To accomplish this flexibility, an optical coupler or combiner 812 combines a broadband signal and a primary signal together and provides this combined signal to the optical filter 10. Similar to that described hereinbefore the optical filter selectively attenuates the combined input signal to adjust the strength as well as the spectral content of the broadband signal. Alternatively, the optical filter 10 may first attenuated the broadband signal and then the Primary Signal is combined with the output signal of the optical filter before being provided to the DUT.

While the variable source 801 may selectively provide a number of test or output signals for performing a number of different tests, as described hereinbefore, the present invention is not limited to these embodiments or tests and contemplates the selectability of any desired filter function to provide any desired output signal. Further, one will appreciated that any input signal 802 may be provided to the optical filter 10 to generated the desired output signal.

The following is a detailed description of the optical filter 10. To simply the description of the optical filter 10 embodying the present invention, the following description of the optical filter will be described as a DGEF. However, as discussed hereinbefore, the optical filter may be programmed or controlled to have any desired filter function to provide any desire output signal.

The DGEF 10 includes a spatial light modulator 36 that comprises a micromirror device 50. The micromirror device includes an array of micromirrors 52 that effectively forms a two-dimensional diffraction grating that is mounted in a retro-reflecting configuration, although other configurations are contemplated by the present invention. The micro-mirrors 52 may be positioned or tilted to provide a filter function that provides varying attenuation of the desired spectral range to flatten or equalize the peaks of the input light 12, such as that amplified by an Erbium-doped fiber amplifier (EDFA).

Each optical channel 14 is dispersed onto the array of micro-mirrors 52 along a spectral axis or direction 55 such that each optical channel or group of optical channels are spread over a plurality of micromirrors. Each channel 14 or group of channels may be selectively attenuated by flipping or tilting a selected number of micromirrors away from the return path to thereby effectively pixelate the optical channels or input signal 12, as will be described in greater detail hereinafter.

Referring to FIG. 1, the DGEF 10 further comprises a three-port circulator 16 for directing light from a first port 18 to a second port 19 and from the second port to a third port 20. An optical fiber or pigtail 22 or other known optical attachment is optically connected to the second port of the circulator 16. A capillary tube 24, which may be formed of glass, is attached to one end of the pigtail 22 such as by epoxying or collapsing the tube onto the pigtail 22. The circulator 16 at the first port 18 receives the WDM input signal 12 from an optical network (not shown), for example, via optical fiber 17, and directs the input light to the pigtail 22. The input beam 12 exits the pigtail 22 (into free space) and passes through a collimator 26, which substantially collimates the input beam. The collimator 26 may be an aspherical lens, an achromatic lens, a doublet, a GRIN lens or similar collimating lens or lens system. The collimated input signal 28 is incident on a wavelength dispersion element 30 (e.g., a diffraction grating), which separates or spreads spectrally the optical channels of the collimated input signal 28 by diffracting or dispersing the light from (or through as in the case of a prism or a transmission grating) the light dispersion element.

In one embodiment, the light dispersion element is a diffraction grating 30 that comprises a blank of polished fused silica or glass with a reflective coating (such as evaporated gold or aluminum), wherein a plurality of grooves 31 (or lines) are etched, ruled or otherwise formed in the coating. The diffraction grating 30 has a predetermined number of lines illuminated on the grating surface, such as 600 lines/mm and 1200 lines/mm. The grating 30 may be similar to those manufactured by Thermo RGL, part number 3325FS-660 and by Optometrics, part number 3-9601. Alternatively, the grating may be formed using holographic techniques, as is well known in the art. Further, the light dispersion element may include a prism or arrayed waveguide to disperse the light as the light passes therethrough, or a prism having a reflective surface or coating on its backside to reflect the dispersed light.

The separated light 32 passes through a bulk lens 34 (e.g., a Fourier lens, cylindrical lens), which focuses the separated light onto the micro-mirror device 50 of the spatial light modulator 36, as shown in greater detail in FIG. 2. A λ/4 wave retardation plate 35 (at for example a nominal wavelength of 1550 nm) may be disposed between the bulk lens 34 and the spatial light modulator 36 to minimize polarization dependent loss (PDL) by compensating for the polarization response of the diffraction grating 30. Alternatively, the λ/4 wave plate may be eliminated by providing a diffraction grating having low PDL characteristics.

Power attenuation of selected wavelength channels is accomplished with a spatial light modulator, which is capable of deflecting a portion of the incident radiation away from the optical path. The remaining undeflected radiation of the optical channels reflects back through the same optical path to the pigtail 22. The equalized optical channels propagate from the second port 19 to the third port 20 of the optical circulator 16 to provide a gain equalized or pre-emphasized output signal 38 from optical fiber 40. While the DGEF 10 attenuates the optical channels to equalize the power of each channel, one will appreciate that the channels may be selectively attenuated to provide any desired gain profile of the output signal 38.

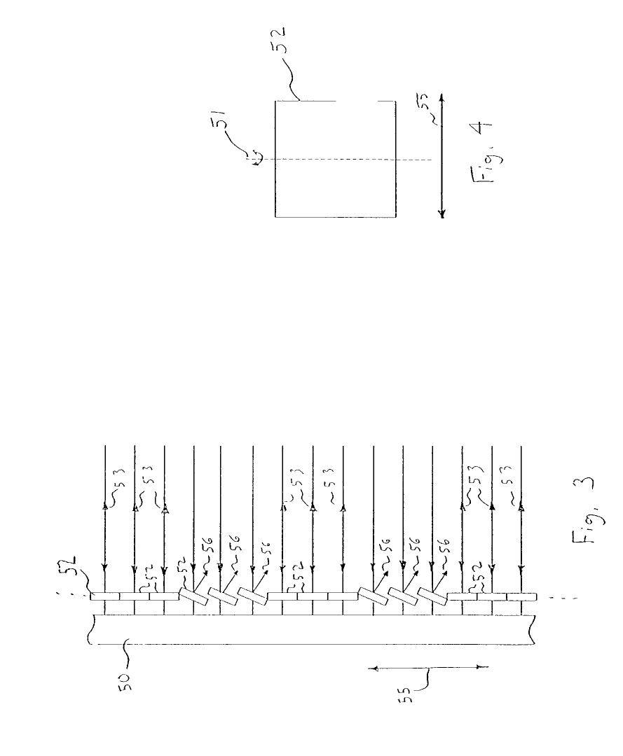

As shown in FIG. 2, the spatial light modulator 36 comprises a micro-mirror device 50 having a two-dimensional array of micro-mirrors 52, which cover a surface of the micro-mirror device. The micro-mirrors 52 are generally square and typically 14-20 μm wide are spaced approximately 1 μm. FIG. 3 illustrates a partial row of micro-mirrors 52 of the micro-mirror device 50. The micro-mirrors may operate in a “digital” manner. In other words, the micro-mirrors either lie flat in a first position and thus reflect light back along the return path, as indicated by arrows 53. Or the micro-mirrors 52 can be tilted, flipped or rotated to a second position such that the micro-mirrors direct light out of or away from the return path at the predetermined angle (e.g., 20 degrees), as indicated by arrows 56. As described herein the positions of the mirrors, either flat or tilted, are described relative to the optical path wherein “flat” refers to the mirror surface positioned orthogonal to the light path, either coplanar in the first position or parallel as will be more fully described herein after. The micro-mirrors 52 flip about an axis 51 perpendicular to the spectral axis 55, as shown in FIG. 4. One will appreciate, however, that the micro-mirrors may flip about any axis, such as perpendicular to the spatial axis 57 or at a 45 degree angle to the spatial axis (i.e., flip about a diagonal axis extending from opposing corners of the micromirrors).

Referring to FIG. 2, the micro-mirrors 52 are individually flipped between the first position and the second position in response to a control signal 56 provided by a controller 58 in accordance with an attenuation algorithm and an input command 60. The switching algorithm may provide a bit (or pixel) map or look-up table indicative of the state (flat or tilted) of each of the micro-mirrors 52 of the array to selectively attenuate the input signal and provide a modified output signal 38 at optical fiber 40. Alternatively, each group of mirrors 52, which reflect a respective optical channel 14, may be individually controlled by flipping a group of micro-mirrors to attenuate the input signal 12.

One will appreciate that the DGEF 10 may be configured for any wavelength plan or spacing scheme by simply modifying the software.

The optical channel plan independence of the filter is a result of being able to spread a single optical channel over any multiple micromirrors. This can be accomplished in practice using spatial light modulators that have very high fill-factors (i.e. very small optical losses <3 dB) due to “dead space” between active modulator elements. In other words, the DGEF 10 is wavelength plan independent. For example, a DGEF for filtering a 50 GHz WDM optical signal may be modified to filter a 100 GHz or 25 GHz WDM optical signal by simply modifying or downloading a different attenuation algorithm, without modifying the hardware. In other words, any changes, upgrades or adjustments to the DGEF (such as varying the spacing of the channels and center wavelength of the light beams) may be accomplished by simply modifying statically or dynamically the attenuation algorithm (e.g., modifying the bit map).

As best shown in FIGS. 1-3, the micro-mirror device 50 is oriented to reflect the focused light back through the bulk lens 34 to the pigtail 22, as indicated by arrows 53, when the micro-mirrors 52 are disposed in the first position, and reflects the focused light away from the bulk lens 34 when the micro-mirrors 52 are disposed in the second position, as indicated by arrows 56. This “digital” mode of operation of the micro-mirrors advantageously eliminates the need for any type of feedback control for each of the micro-mirrors. The micro-mirrors are either “on” or “off” (i.e., first position or second position, respectively), and therefore, can be controlled by simple digital logic circuits.

FIG. 2 further illustrates the outline of the optical channels 14 of the optical input signal 12, which are dispersed off the diffraction gratings 30 and focused by lens 34, onto the array of micro-mirrors 52 of the micro-mirror device 50. The optical channels have an elliptical cross-section to project the beam over a predetermined number of micro-mirrors 52.

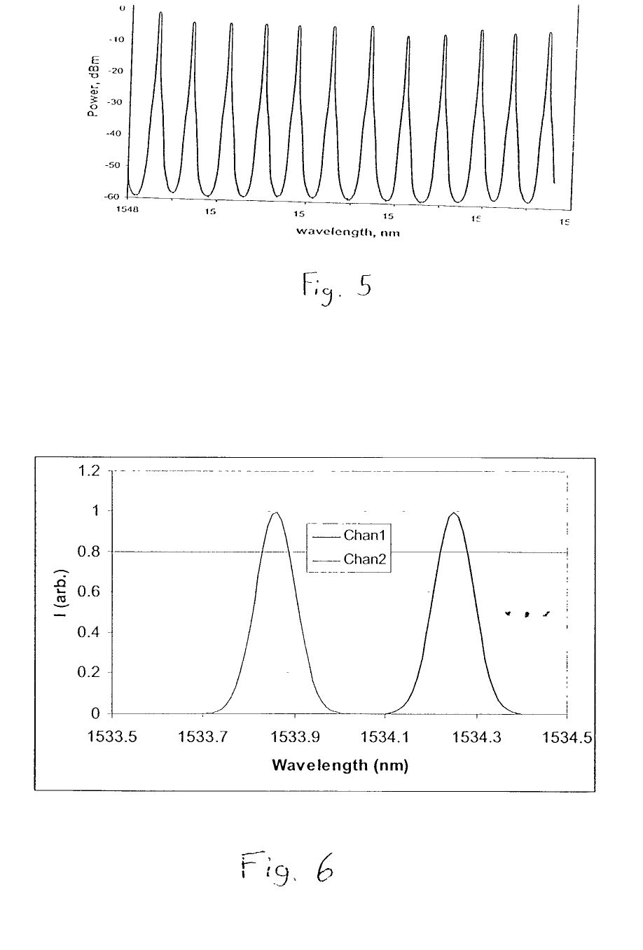

As shown in FIG. 5, the channels 14 of the optical input signal 12 are spaced apart a predetermined distance (e.g., 100 GHz, 50 GHz or 25 GHz spacing) in a non-overlapping manner. Referring to FIG. 6, the optics of the optical filter 10 spread the input signal 12 spectrally over a greater array of the micromirror device such that spacing between the center wavelengths of the channels is increased. Specifically, the grating 30 and the Fourier lens 34 defined the spacing between the optical channels imaged onto the micromirror device. Further, the optics of the optical filter 10 spread spectrally the width of each individual channel that is imaged onto the micromirror device 36. Specifically, the width of the optical beam of each channel imaged onto the micromirror device 36 is defined by the collimating lens 26 and the Fourier lens 34.

One will appreciate though that the diffraction grating 30 and Fourier lens 34 may be designed to reflect and focus any optical channel or group of optical channels with any desired cross-sectional geometry, such as elliptical, circular, rectangular, square, polygonal, etc. Regardless of the cross-sectional geometry selected, the cross-sectional area of the channels 14 should illuminate a plurality of micro-mirrors 52.

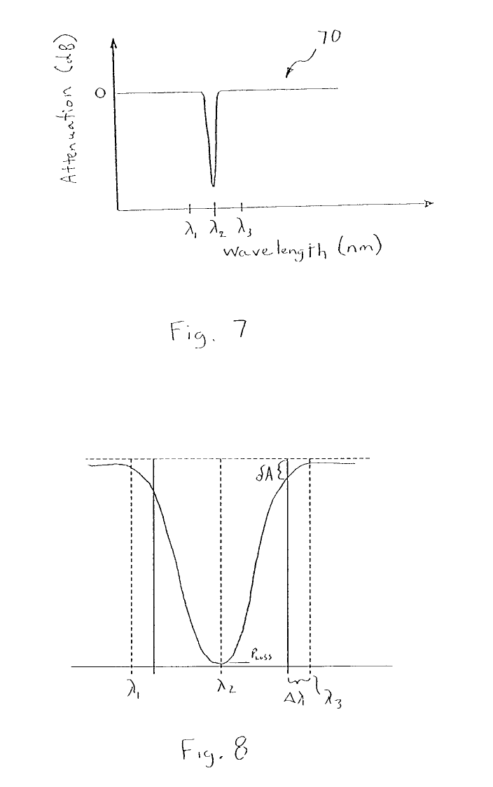

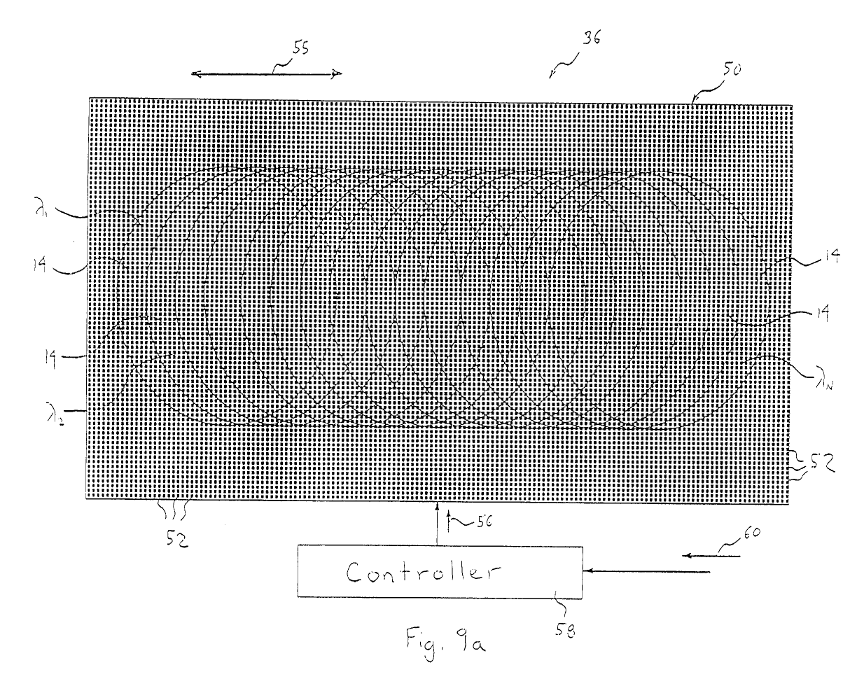

As shown in FIGS. 2 and 6, the optical channels 14 are dispersed and have an elliptical cross-section, such that the optical channels do not substantially overlap spectrally when focused onto the spatial light modulator 36. For example, as shown in FIG. 6, the optical channels 14 are sufficiently separated such that when a channel is substantially attenuated or dropped (e.g. approximately 30 dB power loss) the adjacent channels are attenuated less than approximately 0.1% for unmodulated signals and less than approximately 0.2% for a modulated signal. In other words, as shown in FIG. 7 and 8, the optical channels are substantially separated and non-overlapping when an optical channel is attenuated or dropped (P_{Loss}) such that the power of the adjacent channel drops less than a predetermined level (δA) at a predetermined delta (Δf) from the center frequency (or wavelength) of the adjacent channels. For example, for a 50 GHz WDM input signal wherein an optical channel at λ₂ is attenuated (P_{Loss}) greater than 30dB, the loss (δA) at adjacent channels is approximately less than 0.2dB at the channel center +/−10 GHz.

While the cross-sectional area and geometry of the optical channels 14 described and shown hereinbefore are uniform from channel to channel, one will recognize that the cross-sectional area and geometry may vary from channel to channel. Further, one will appreciate that while the spacing between the channels is shown to be uniform, the spacings therebetween may vary. For example, one grouping of channels may be spaced to correspond to a 100 GHz spacing, and another group of channels that are spaced to correspond to a 50 GHz spacing.

To attenuate an optical channel 14, for example, such as that centered at wavelength λ₂, a predetermined number of micro-mirrors 34 disposed in the area illuminated by the optical channel at λ₂ are tilted to reflect a portion of the light of the optical channel away from the return path 53. One will appreciate that each portion or pixel of light, which is reflected away from the return path, attenuates the optical channel by a percentage defined by the number of micro-mirrors 34 illuminated by the optical channel at λ₂. For example assuming each optical channel 14 illuminates 300 micro-mirrors; each micro-mirror is representative of approximately 0.3% attenuation (or approximately 0.01 to 0.02 dB) of the optical signal when the micro-mirror is tilted away. The above example assumes that the intensity of the light of each optical channel is uniform over the entire cross-section of the beam of light. One will appreciate that the intensity spatial profile of the beam of the optical channel may be Gaussian, as shown in FIG. 6, and therefore, the beam intensity illuminating the pixels at the edges (wings) of the beams of the optical channels 14 is less than the center portion of the beams, which advantageously increases the resolution of the selectable attenuation of the optical channel or band.

FIG. 7 is representative of an optical filter function 70 of the optical filter 10, wherein a number of the micro-mirrors 52 illuminated by the optical channel 14 at λ₂ are tilted away 56 from the return path, and the micro-mirrors of the other optical channels at wavelengths at λ₁, λ₃, −λ_{N} are flat (i.e., first position) to reflect the light back along the return path 53. Effectively, the optical channel 14 at λ₂ is dropped from the input light 12. As described hereinabove, the attenuation of the optical channel at λ₂ may be adjusted by tilting a predetermined number of micro-mirrors to drop a corresponding amount of light to achieve the desired level of loss.

While the micro-mirrors 52 may switch discretely from the first position to the second position, as described hereinabove. The present invention contemplates moving the micro-mirrors continuously (in an “analog” mode) or in discrete incremental steps between the first position and second position. In these modes of operation, the micro-mirrors can be tilted in a continuous range of angles or a plurality of discrete steps (>2 positions). The greater range of angles of each individual micro-mirror provides the added benefit of much more attenuation resolution than in the two, position digital mode described hereinbefore. In the “analog” mode, each micro-mirror 52 can be tilted slightly allowing fully continuous attenuation of the return beam.

In FIGS. 9a-c, another embodiment of an optical filter is shown, which is similar to the optical filter 10 shown in FIGS. 1-3, except the diffraction grating 30 disperses the optical channels 14 of the input light 12 onto the micro-mirror device 50, such that the optical channels are not substantially separated, as defined hereinbefore, but overlapped, and have a generally circular cross-section. FIG. 9a shows an embodiment wherein the optics (i.e., collimating lens 26 and bulk lens 34) spread or disperse the input light onto the micromirror device such that the optical channels substantially overlap. FIGS. 9b and 9c show embodiments with varying degrees of overlap of the optical channels imaged onto the micromirror device. While present invention describes the optical channels having a generally circular cross-section, one will appreciate the cross-section may be elliptical or other geometric shape.

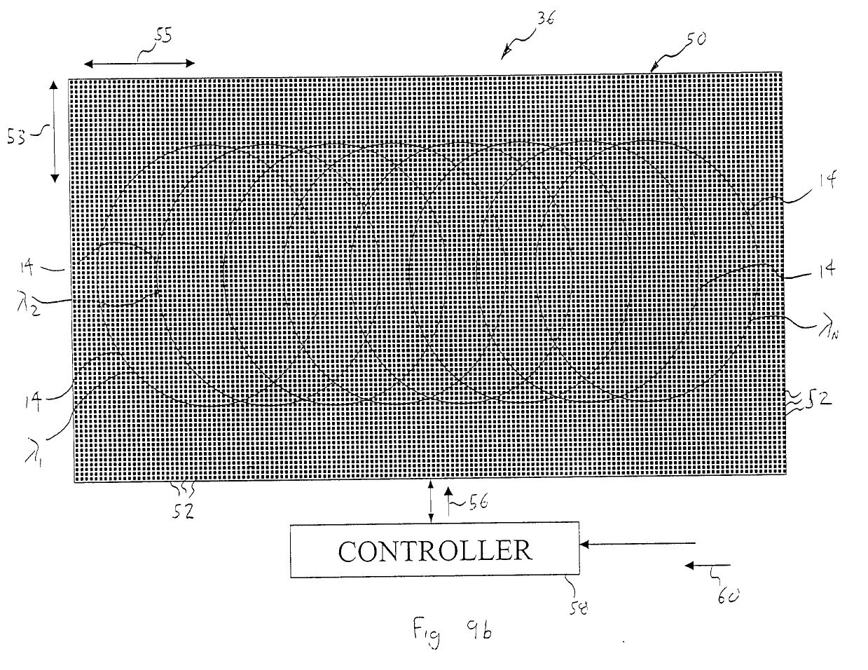

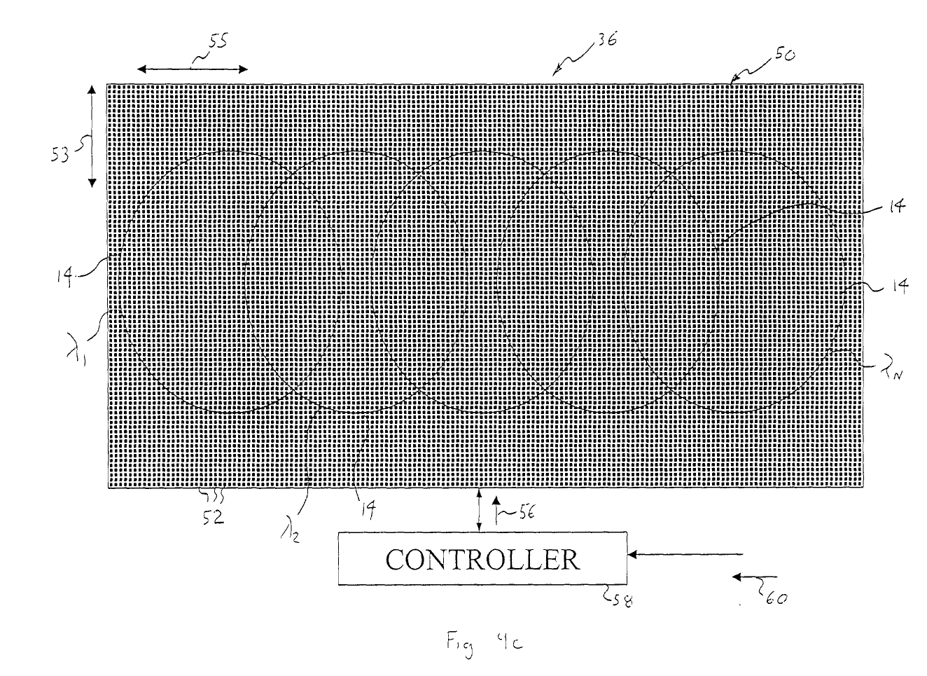

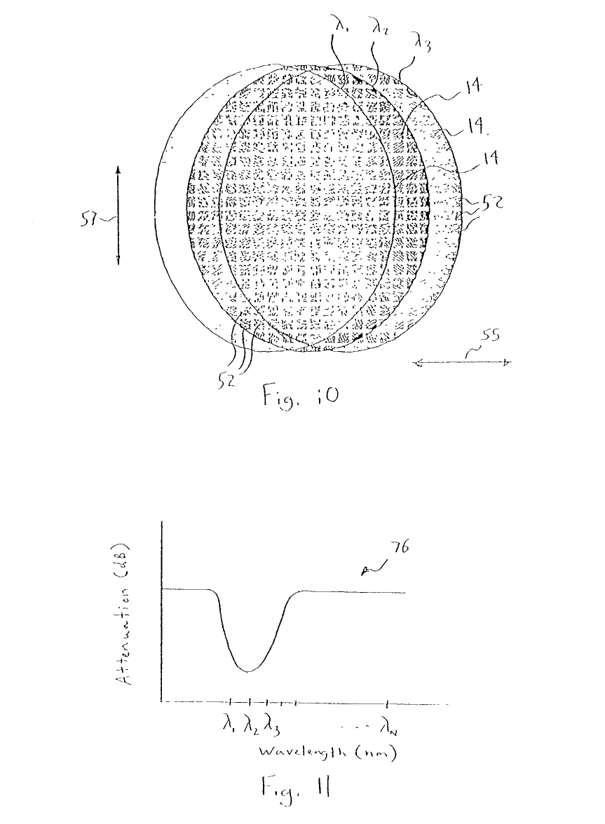

FIG. 10 shows the intensity distribution for three 50-GHz separated optical ITU channels of FIG. 9. The position in the spectral domain of the attenuation is determined by actuating micro-mirrors 52 in a specific spectral region of the device along the spectral direction 55. Variable attenuation in a given spectral band is achieved by actuating micro-mirrors primarily along the spatial direction 57 at the preselected spectral position. As described hereinbefore, the number of micro-mirrors 52 that are tilted determines the attenuation of the optical channel 14 or spectral band. One will note, however, that some of the micro-mirrors reflect light of more than one optical channel or band, and therefore when such a micro-mirror is tilted away from the return path, each corresponding optical channel is attenuated by a predetermined amount. Consequently, if, for example, a substantial number of the micro-mirrors 52 illuminated by the optical channel 14 at λ₂ are titled away from the return path, not only will the optical channel at λ₂ be fully attenuated, but also a substantial portion of the adjacent optical channels (i.e., at λ₁, λ₃) will be attenuated, as shown in FIG. 11. FIG. 11 shows the optical filter function 76 of the optical filter of FIG. 9, wherein a substantial number of the micro-mirrors 52 that are illuminated by the optical channel at λ₂ are tilted away from the return path. Advantageously, the overlapping of the optical channels 14 on the micro-mirror device 50 provides for a smooth attenuation transition between optical channels or bands.

In another exemplary embodiment, a DGEF 80 is provided in FIGS. 12a and 12b that is substantially similar to the DGEF 10 of FIGS. 1 and 2, and therefore, common components have the same reference numeral. The DGEF 80 replaces the circulator 28 of FIG. 1 with a second pigtail 82. The pigtail 82 has a glass capillary tube 84 attached to one end of the pigtail. The pigtail 82 receives the optical channels reflected from the micro-mirror device 50 (FIG. 10) back along a return optical path 53. Note that in FIG. 12a pigtails 82 and 24 in one embodiment (in reality) are coplanar in the top view and are shown as separate in the view for illustration purposes. Specifically, pigtail 82 receives the compensated optical channels 14 (FIG. 10) reflected back along the return optical path 53, which are reflected back from the spatial light modulator 36. Lens 34 of the embodiment shown is a cylindrical lens to separate the source path 32 and the return path 55 and thereby accommodates the separate source and receive pigtails 27,82. In another embodiment the pigtail 22, the light dispersive element 30 and/or the spatial light modulator 36 are tilted or positioned to offset the reflected path 53 such that the reflected light is focused on the second pigtail 82. The true separation of the source path 28, 32 and the return path 53 is best shown in FIG. 12b.

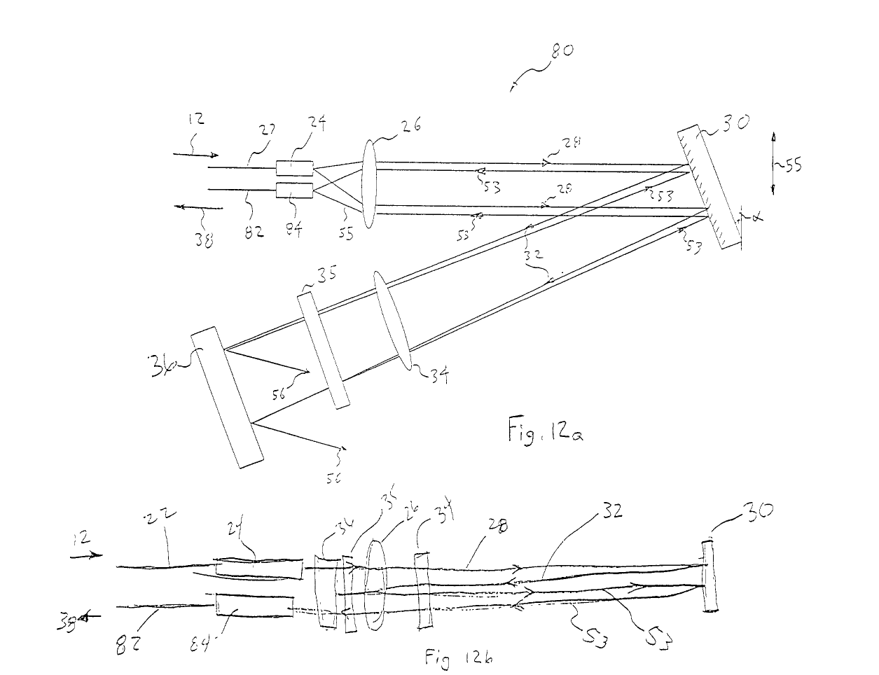

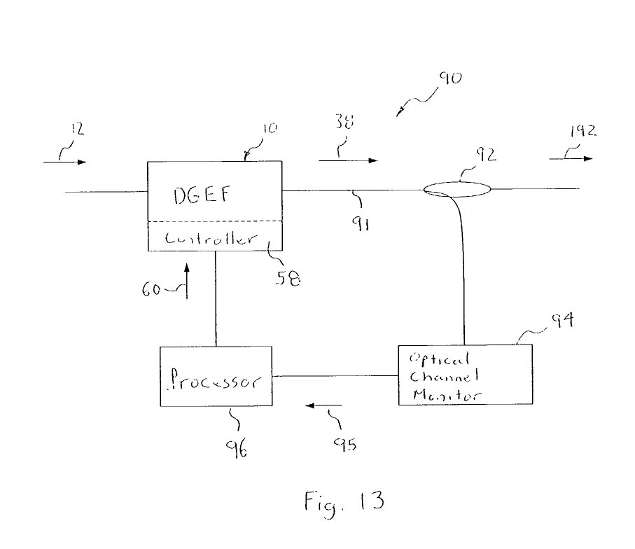

Referring to FIG. 13, a closed-loop system 90 is provided wherein an input signal 12 is provided to the DGEF 10, which selectively attenuates the optical channels 14 or wavelength bands to equalize the power of the input signal over a desired spectrum, and outputs an equalized output signal 38 at an optical fiber 91. An optical coupler 92 taps off a portion of the equalized output signal 38 of the DGEF 10 to an optical channel monitor (OCM) or optical signal analyzer (OSA) 94. The channel monitor 94 provides a sense signal 95, which is indicative of at least the power or gain of each optical channel 14 or wavelength band. In response to the sense signal 95, a processor 96 generates and provides the control signal 60 to controller/interface board 58 which in turn commands the micro-mirror device 50 (see FIG. 2) to flip the appropriate micro-mirrors 52 to attenuate (e.g. flatten or equalize) the input signal 12, as will be described in greater detail hereinafter.

The micro-mirror device 50 of FIGS. 1 and 2 may be similar to the Digital Micromirror Device™ (DMD™) manufactured by Texas Instruments and described in the white paper entitled “Digital Light Processing™ for High-Brightness, High-Resolution Applications”, white paper entitled “Lifetime Estimates and Unique Failure Mechanisms of the Digital Micromirror Device (DMD)”, and news release dated September 1994 entitled “Digital Micromirror Display Delivering On Promises of ‘Brighter’ Future for Imaging Applications”, which are incorporated herein by reference.

FIG. 14 illustrates a pair of micro-mirrors 52 of such a micromirror device 100 manufactured by Texas Instruments, namely a digital micromirror device (DMD™). The micromirror device 100 is monolithically fabricated by CMOS-like processes over a CMOS memory 102. Each micro-mirror 52 includes an aluminum mirror 104, approximately 16 μm square, that can reflect light in one of two directions, depending on the state of the underlying memory cell 102. Rotation, flipping or tilting of the mirror 104 is accomplished through electrostatic attraction produced by voltage differences between the mirror and the underlying memory cell. With the memory cell 102 in the on (1) state, the mirror 104 rotates or tilts approximately +10 degrees. With the memory cell in the off (0) state, the mirror tilts approximately −10 degrees. As shown in FIGS. 14 and 15, the micro-mirrors 72 flip about an axis 105.

FIG. 16 illustrates the orientation of a micro-mirror device 100 similar to that shown in FIG. 14, wherein neither the on or off state of the micro-mirrors 52 is parallel to the base or substrate 110, as shown in FIG. 3. Consequently, the base 110 of the micro-mirror device 100 is mounted at a non-orthogonal angle α relative to the collimated light 32 (see FIG. 1) to position the micro-mirrors 52, which are disposed at the first position, perpendicular to the collimated light, so that the reflected light off the micro-mirrors in the first position reflect substantially back through the return path, as indicated by arrows 53. Consequently, the tilt angle of the mirror between the horizontal position and the first position (e.g., 10 degrees) is approximately equal to the angle α of the micro-mirror device.

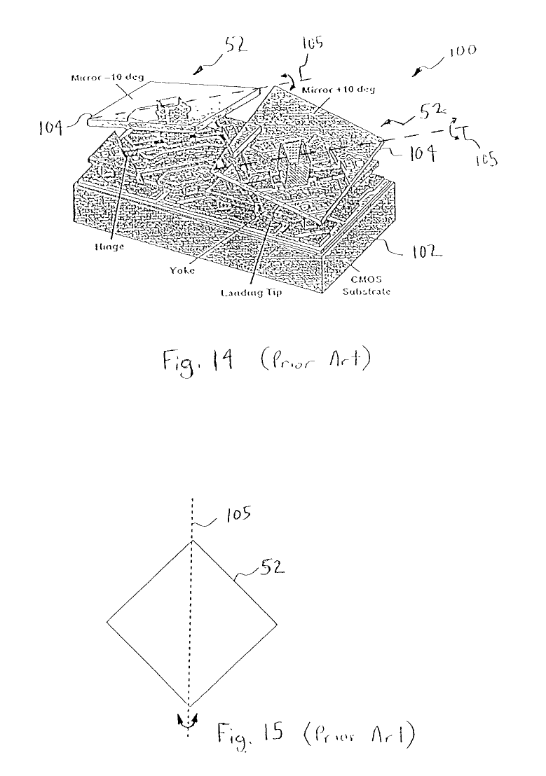

In using the micro-mirror array device 100, it is important that the reflection from each micro-mirror 72 adds coherently in the far-field, so the angle a to which the micro-mirror device 100 is tilted has a very strong influence on the overall efficiency of the device. FIG. 17 illustrates the phase condition of the micro-mirrors in both states (i.e., State 1, State 2) for efficient reflection in either condition.

In an exemplary embodiment of the micro-mirror device 100, the effective pixel pitch ρ is about 19.4 μm, so for a mirror tilt angle β of 9.2 degrees, the array is effectively blazed for Littrow operation in the n=+2 order for the position indicated as Mirror State 1 in FIG. 17 (i.e., first position for a wavelength of about 1.55 μm). For Mirror State 2, the incident angle γ on the micro-mirror device 100 is now 9.2 degrees and the exit angle ε from the array is 27.6 degrees. Using these numbers, the micro-mirror device is nearly blazed for fourth-order for mirrors in Mirror State 2.

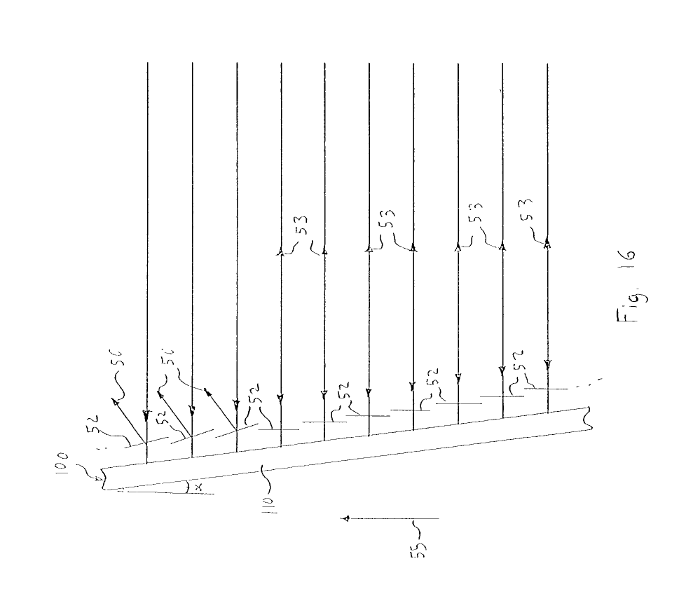

FIG. 18 graphically illustrates the micro-mirror device 100 wherein the micro-mirrors 52 are disposed in the retro-reflective operation (i.e., first position), such that the incident light reflects back along the return path 53 (see. FIG. 1). For retro-reflective operation, the micro-mirror device 100 acts as a blazed grating held in a “Littrow” configuration, as shown in FIG. 1, with the mount angle (α) equal to the mirror tilt “β” or blaze angle (e.g., 9.2 degrees). The grating equation (i.e., sinθ₁, +sin θₘ=mλ/d) provides a relationship between the light beam angle of incidence (θ₁) angle of reflection, (θₘ) the pitch (d) of the micro-mirror array; the mirror tilt; and the wavelength of the incident light (λ). Introducing the micro-mirror device 100 at the focal plane 115 implements the critical device feature of providing separately addressable groups of mirrors to reflect different wavelength components of the beam. Because of the above reflection characteristics of the micro-mirror device 100, with the micro-mirror 100 in the focal plane 115, the beam is reflected as from a curved concave (or convexed) mirror surface. Consequently, when the micro-mirror device is oriented to retro-reflect at a wavelength hitting near the mirror center, wavelengths away from the center are reflected toward the beam center (FIG. 1) as if the beam were reflected from a curved concave mirror. In other words, the micro-mirror device 100 reflects the incident light 112 reflecting off the central portion of the array of micro-mirrors directly back along the incident angle of the light, while the incident light 112 reflecting off the micro-mirrors disposed further away from the central portion of the array progressively direct the light inward at increasing angles of reflection, as indicated by arrows 114.

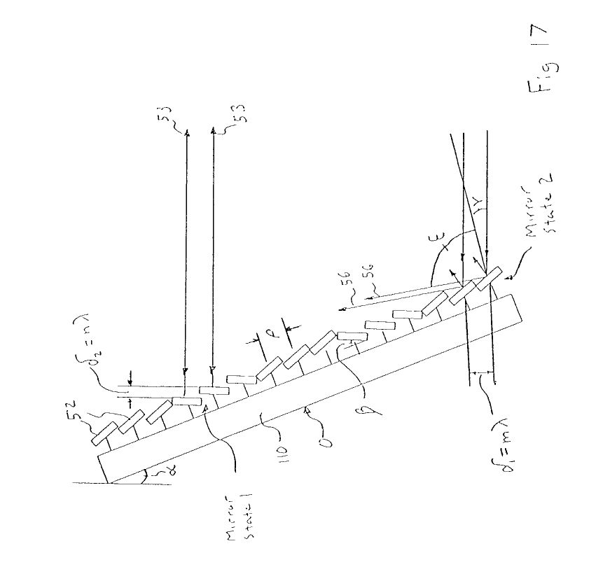

FIGS. 19a and 19b illustrate a technique to compensate for this diffraction effect introduced by the micromirror array, described hereinbefore. FIG. 19a illustrates the case where a grating order causes the shorter wavelength light to hit a part of the micromirror array 100 that is closer than the section illuminated by the longer wavelengths. In this case the Fourier lens 34 is placed at a distance “d” from the grating 30 that is shorter than focal length “f” of the Fourier lens. For example, the distance “d” may be approximately 71 mm and the focal length may be approximately 82 mm. It may be advantageous to use this configuration if package size is limited, as this configuration minimizes the overall length of the optical train.

FIG. 19b illustrates the case where the grating order causes the longer wavelengths to hit a part of the micromirror array 100 that is closer than the section illuminated by the shorter wavelengths. In this case the Fourier lens is placed a distance “d” from the grating 30 that is longer than focal length “f” of the Fourier lens 34. This configuration may be advantageous to minimize the overall area illuminated by the dispersed spectrum on the micromirror array.

Alternatively, the effective curvature of the micro-mirror device 100 may be compensated for using a “field correction” lens 122. In an exemplary embodiment shown in FIG. 20, the DGEF 120 is similar to the DGEF 10 of FIG. 1, and therefore similar components have the same reference numeral. The DGEF 120 includes a field correction lens 122 disposed optically between the λ/4 wave plate 35 and the spatial light modulator 130. The “field correction” lens 122 respectively compensates for the attenuated channels reflecting off the spatial light modulator 130.

As described hereinbefore, the micro-mirrors 52 of the micro-mirror device 100 flip about a diagonal axis 105 as shown in FIGS. 12 and 18. In an exemplary embodiment of the present invention shown in FIG. 18, the optical input channels 14 are focused on the micro-mirror device 100 such that the long axis 124 of the elliptical channels 14 is parallel to the tilt axis 105 of the micro-mirrors. This configuration is achieved by rotating the micro-mirror device 100 by 45 degrees compared to the configuration shown in FIG. 2. Focusing the optical channels in this orientation maximizes the ability to control the attenuation step and chromatic dispersion. By limiting the width of the projection on the mirrors in the spectral dimension the path length difference from one wavelength to another is minimized and thereby minimizes the chromatic dispersion. Alternatively, the elliptical channels 14 may be focused such that the long axis 124 of the channels is perpendicular to tilt axis 105 of the micro-mirrors. Further, one will appreciate that the orientation of the tilt axis 105 with respect to the long axis 124 may be any angle.

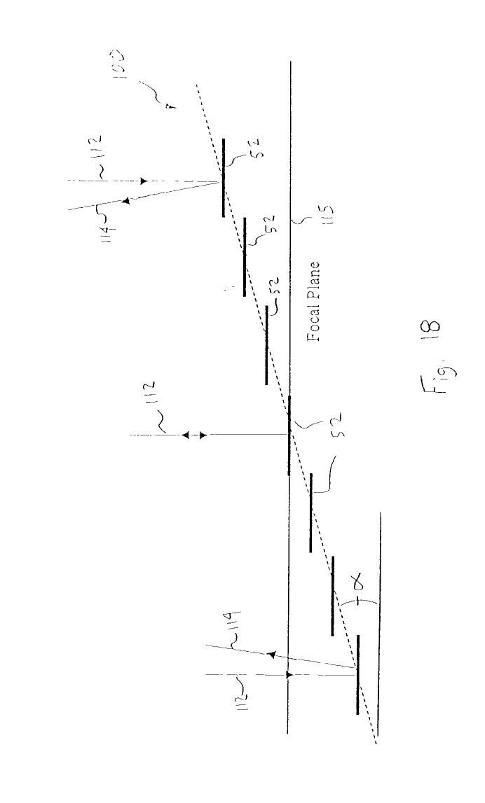

In an exemplary embodiment shown in FIG. 21, the micro-mirror device 100 is divided into a set of adjacent “sections” that are a specified number of micro-mirrors 52 (or pixels) wide by a specified number of micro-mirrors high. The “Section Height” is defined as the number of corner-to-corner pixels in the spatial direction. The “Section Width” of the sections is defined as the number of interlaced pixels of each section. As shown, the section width and section height for each section are two (2) and six (6), respectively.

An “Attenuation Step” is defined as the number of pixels turned off within a selected section. The maximum attenuation step value is the product of the Section Width and Section Height, and therefore the maximum attenuation step of each section is 12 (i.e., 2*6).

Each section is numbered outward from zero with sections to the left of section 0 being positive and the sections to the right of section 0 being negative. The section 0 is at the spatial center of the section pattern. The origin of the entire pattern is the upper left hand corner of section 0. As shown in FIG. 21 for example, section —3 is shown at maximum attenuation step of 12, and section 0 is shown having an attenuation step of 7. All other sections have an attenuation step of zero (0). Sections 3 and 4 are shaded to illustrate the pattern of the sections on the micro-mirror device 100. Optical channels 14 centered at λ₁, λ₂ substantially reflect a selected section.

The attenuation algorithm receives input indicative of the power of the optical channels 14 or wavelengths over the selected spectrum of the WDM signal. After eliminating channels that are not powered (i.e. the power level is below some predetermined threshold level) the algorithm compares the gain profile of the WDM signal and determines a set of attenuations versus wavelength. The attenuation algorithm takes the set of attenuations versus wavelength {λ₁₅Aᵢ} and turn them into a list of section “Attenuation Step” versus Section Number. The algorithm then commands the micro-mirror device 100 to flip the appropriate micro-mirrors 52.

Specifically, the amount of power coupled back to the fundamental mode in the fiber after the collimator can be shown to be

P_{C}(λ)=|∫I(ρ;λ)D(ρ)d²ρ|² (1)

where I(ρ;λ) is the intensity pattern of the beam on the micro-mirror device 100 for a given wavelength, D(ρ) is the complex spatial pattern of “on” pixels on the micro-mirror device 100, and β=xₛ\hat{x}ₛ+yₛŷₛ is the transverse spatial coordinate vector. The function D has constant phase if the micro-mirror device 100 lies in a true Fourier plane (effective focal plane) of the system and optical aberrations and focusing errors are small compared to wavelength.

Due to the diffraction grating 30, the wavelength dependence of I(ρ) can be expressed as I(ρ)=Iₓ (xₛ−ρβ)I_{y} (yₛ) where Iₓ and I_{y} are the beam shapes in the xₛ and yₛ direction respectively, and β is a calibration coefficient.

The spatial pattern on the micro-mirror device 100 can be expressed as a sum of spatially distinct sections

$$D ( ρ ) = {\sum }_{i = 1}^{N} S ( {x}_{s} - γ {λ}_{i} ) R ( {y}_{s} ; {h}_{i} ) \qquad ( 2 )$$

where S(xₛ) is a function of the effective “shape” of the section of the micro-mirror device 100 in the spectral direction (for example they are triangular due to the “diamond” shape of the micro-mirrors 52 when using a suitably oriented DMD device), and R(y) is approximated as a “rectangle” function that is unity for |yₛ|<h and zero otherwise.

Collecting the above results, one obtains

$$\sqrt{Pc ( λ )} = {\sum }_{i = 1}^{N} M ( λ , {λ}_{1} ) {L}_{M} ( {h}_{i} ) \qquad ( 3 )$$

where the matrix M is essentially the instrument response function convolved with the pixel shape function S. Experimentally, this function is known to be Gaussian to good approximation.

The reflected power off Section j at the peak λⱼ (L_{M}(hⱼ) ) can be calculated with a couple of assumptions. Assuming the beam is spatially separable and the beam has a Gaussian shape in the spatial dimension yₛ,

$${L}_{M} ( {h}_{j} ) \approx 1 - C [ erf ( \frac{H}{{w}_{y}} ) - erf ( \frac{H - hj}{{w}_{y}} ) ] \qquad ( 4 )$$

where hⱼ is the physical height of the “off” pixels for the j'th section on the micro-mirror device 100, H is the physical height of the sections of the micro-mirror device 100, C is called the “spectral overlap”, which is a single semi-empirical parameter which describes the spectral beam shape and pixel shape details, and w_{y} is the Gaussian 1/e HW of the beam in the spatial direction. Note that the “Attenuation Step” AS is related to the parameter AS=w*hⱼ/p, where p is the length of an individual pixel and w is the width (in number of pixels) of the section of the micro-mirror device 100.

Although this model allows one to predict what a filter will look like at a given Attenuation step for a given Section Number, a different problem is usually faced. Typically one is supplied with a set of {λ₁, A₁}, where A₁=10 log₁₀(P_{C}(λ_{C1})) and there is a need to solve for the h vector. Note that the command wavelengths λ_{c1} (which typically lie on the ITU grid)probably don't correspond to sections λᵢ of the micro-mirror device 100.

To do this we use the following procedure. First the matrix M is approximated as a Gaussian. The loss at an arbitrary wavelength can be approximated from Equation (3) as

$$\sqrt{{P}_{C} ( λ )} = {\sum }_{j = 1}^{N} {L}_{M} ( {h}_{j} ) {N}_{j} exp [ - {( \frac{λ - {λ}_{j}}{{w}_{j}} )}^{2} ] \qquad ( 5 )$$

where Nⱼ is a normalization constant. The parameters (center wavelength and width) of each section are determined empirically.

One turns the A (usually in dB) into linear loss vector L. L is sampled onto the set of wavelengths defined by the sections to get Lₛₜ=\sqrt{P_{c}(λₜ)} Equation (5) defines a sparse matrix operator equation that can be inverted using standard techniques to yield the L_{M} solution vector. The Attenuation Step is then found from a look up table of Attenuation Step for a given linear attenuation L_{Mi} as calculated from Equation (4).

Note that using the above method the operator matrix M is inverted a single time. The same inverted matrix can be used to calculate the solution L_{M} given a new Lₛ vector.

Two complications are worth noting. First, in order for the above technique to be stable some assumptions are made about Lₛ, namely, that the function Lₛ(λ) is “frequency limited” (here frequency refers to the rate of change of the amplitude of the filter from one point in the spectrum to another.) Since this is not necessarily the case, a regularization filter is applied to the input vector L to explicitly frequency limit the function Lₛ. The regularization filter is implemented as a Gaussian convolution filter with a frequency limit set to about 1.25 the spectral resolution of the system. This introduces some error into the calculation if filter features are requested that are on the order of the spectral resolution of the system.

To mitigate the error introduced by the regularization filter, a second iterative procedure is applied to the resultant h vector to bring the filter values into agreement at the commanded wavelengths. Given the vector h, the resulting attenuation values L_{c} are calculated at the command wavelengths. The difference between the commanded attenuations L and the calculated attenuations L_{c}^{P} for the p-th iteration is then “fed back” into a new “command” vector L_{c}^{P+1}. Note that L_{c}^{P}=L calculated from the inverse of the filter operator matrix and the regularized input data.

Mathematically, this process is

L_{c}^{p+1}=L_{c}^{P}−ΔL_{c} (6a)

ΔL_{c}=L−L_{c}^{p} (6b)

After the maximum value of L_{c}^{P+1} is below a given “critical ripple”, the ripple reaches a minimum, or a maximum number of iterations is performed, the loop is stopped.

Note that the above procedure tends to cause the filter to “ring” through the command points if features are requested that are close to the resolution limit of the system. A more sophisticated algorithm would keep track of not only the attenuation value at a given command wavelength but also the curvature of the filter (i.e. dispersion) in order to calculate the “best” filter given a constraint on dispersion as well as amplitude. One simple modification would be to sample not only on the command wavelengths but also at two neighboring points on either side of the command wavelength and require the curvature defined by those three points to be beneath a critical value as well as the loss being close to all three points.

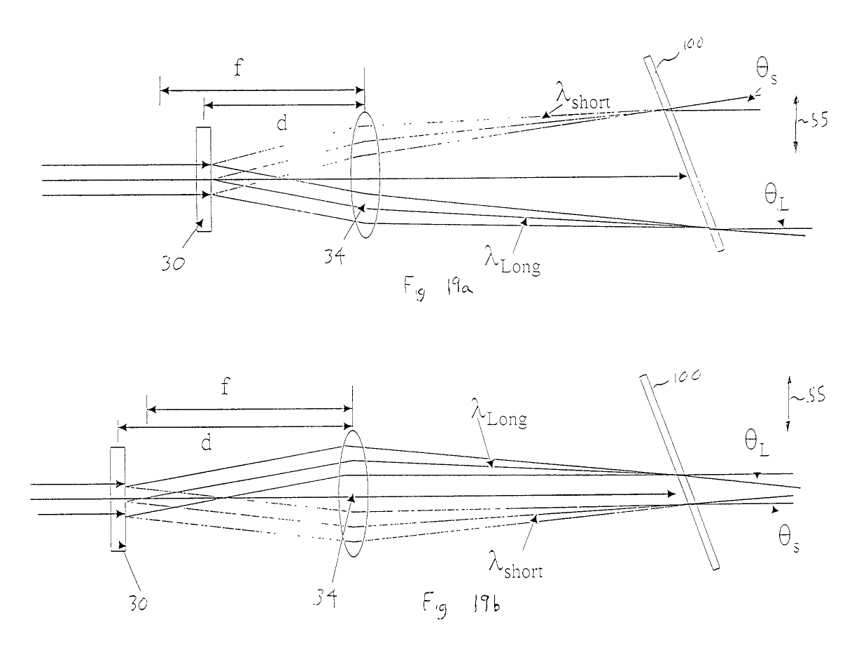

FIGS. 22-25 show data of a DGEF similar to that shown in FIG. 1 having a micro-mirror device 100, as described hereinbefore, whereby the flipping of the micro-mirrors is controlled by the above described gain equalizing algorithm. FIG. 22 compares a desired or commanded filter profile 180, having 10 dB loss at a selected wavelength with the slopes of the function being 2.5 dB/nm, to the actual filter profile 182 provided by the DGEF. FIG. 23 shows the error 184 in dB between the commanded filter profile 180 and the actual filter profile 182 of FIG. 22.

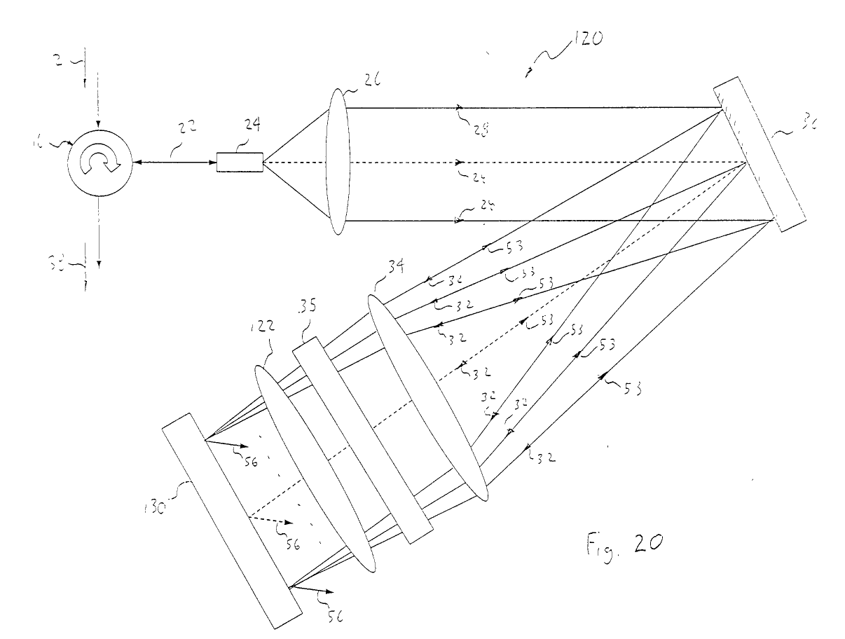

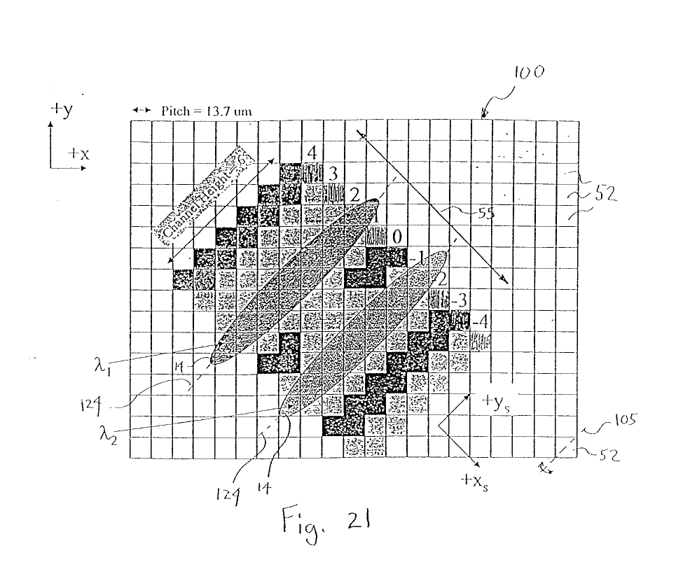

FIG. 24 compares a commanded filter profile 186, having a more complex function than that shown in FIG. 22, to the actual filter profile 188 provided by the DGEF. FIG. 25 shows the error 190 in dB between the commanded filter profile 186 and the actual filter profile 188 of FIG. 22.

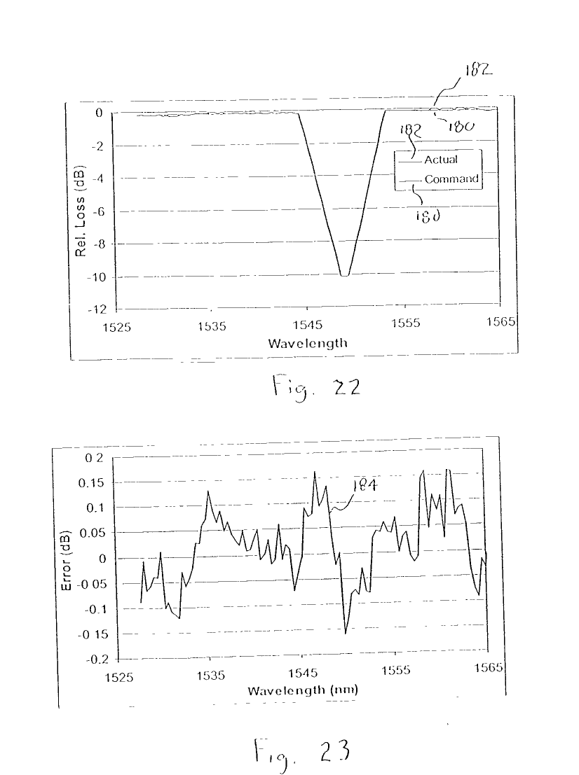

FIGS. 26 and 27 show data representing the input signal 12 and equalized output signal 192, respectively, of a closed-loop DGEF system 90 (similar to that in FIG. 13), which includes a DGEF similar to that shown in FIG. 1 having a micro-mirror device 100, as described hereinbefore, whereby the flipping of the micro-mirrors is controlled by the above described gain equalizing algorithm. FIG. 26 shows a 50 GHz WDM signal 12 having unequalized optical channels. FIG. 27 shows the resulting equalized output signal 192 of the DGEF system 90, whereby the error between each of the gain of each of the optical signals 14 is between +/−0.2 dB.

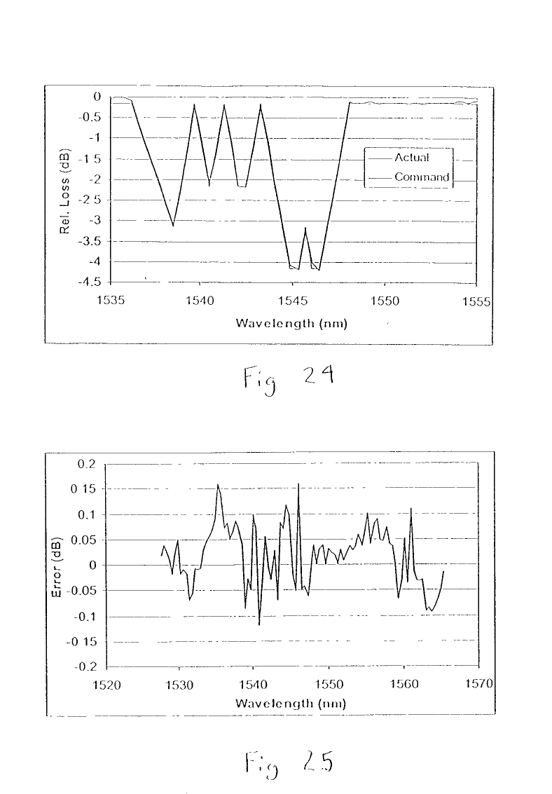

In the operation of an embodiment of the micro-mirror device 100 manufactured by Texas Instruments, described hereinbefore, all of the micro-mirrors 52 of the device 100 releases when any of the micro-mirrors are flipped from one position to the other. In other words, each of the mirrors will momentarily tilt towards the horizontal position (or “flat” position) upon a position change of any of the micro-mirrors. Consequently, this momentary tilt of the micro-mirrors 52 creates a ringing or flickering of the light reflecting off the micro-mirrors. To reduce or eliminate the effect of the ringing of the light during the transition of the micro-mirrors 52, the light may be focused tightly on the micro-mirror device 100. FIGS. 28 and 29 illustrate the effect of the ringing of micro-mirrors during their transition. Both FIGS. 28 and 29 show an incident light beam 210, 212, respectively, reflecting off a mirror surface at different focal lengths. The light beam 210 of FIG. 28 has a relatively short focal length, and therefore has a relatively wide beam width. When the micro-mirror surface 214 momentarily tilts or rings a predetermined angle τ, the reflected beam 216, shown in dashed lines, reflects off the mirror surface at the angle τ. The shaded portion 218 is illustrative of the lost light due to the momentary ringing, which represents a relatively small portion of the incident light 210. In contrast, the light beam 212 of FIG. 29 has a relatively long focal length, and therefore has a relatively narrow beam width. When the micro-mirror surface 214 momentarily tilts or rings a predetermined angle τ, the reflected beam 220, shown in dashed lines, reflects off the mirror surface at the angle τ. The shaded portion 222 is illustrative of the lost light due to the momentary ringing, which represents a greater portion of the incident light 212, than the lost light of the incident light. Consequently, the sensitivity of the momentary tilt of the micro-mirrors is minimized by tightly focusing the optical channels on the micro-mirror device 100. Advantageously, tightly focusing of the optical channels also reduces the tilt sensitivity of the micro-mirror device due to other factors, such as thermal changes, shock and vibration.

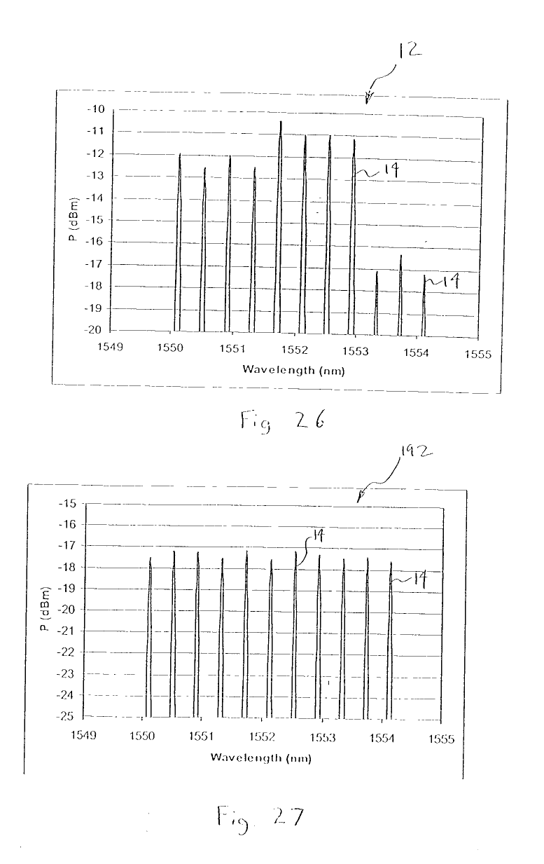

FIG. 30 illustrates another embodiment of DGEF 230 in accordance with the present invention, which is similar to the DGEF of FIG. 1, and therefore like components have the same reference numerals. Unlike the DGEF of FIG. 1, the DGEF 230 flip the micro-mirrors 52 of the spatial light modulator 36 to direct the equalized output signal 38 away from the return path 53 to thereby direct the output signal along optical path 56. The output signal 38 passes through a complimentary set of optics, such as a second bulk lens 234, a second λ/4 wave plate 235, a second diffraction grating 236, and a second collimating lens 238 to a second pigtail 240. Conversely, the attenuated portion of the light is reflected back through return path 53 to pigtail 22. An optical isolator 242 is provided at the input of the DGEF 230 to prevent this light from returning to the optical network.

While the present invention has been described as a DGEF, one will recognize that each of embodiments described hereinbefore are not limited to equalizing the optical channels 14 or wavelengths over a desired spectrum of an WDM input signal 12, but may be used to provided any desired filter profile resulting in any desired output attenuation profile.

Referring to FIG. 31 there is shown by way of example an embodiment of the invention described herein above and generally referred to as DGEF 500 like components have the same reference numerals. In the schematic of the embodiment shown light enters DGEF 500 via pigtail or fiber 22 and passes through collimating lens 26. The collimated input beam 28 is incident on a wavelength dispersion element 30 (e.g., a diffraction grating), which disperses spectrally the optical channels of the collimated input beam by diffracting or dispersing the light from the light dispersion element. The curved reflector lens 132 (e.g., cylindrical lens or Fourier lens) projects and separates optical channels or bands of channels 134, 135 onto micro-mirror device 36 as described herein above. Curved reflector lens 132 is positioned a nominal distance “d” 133 from the diffraction grating where d is less than the focal distance of the curved lens. The light 502, 503 reflected off of curved lens 132 is projected onto turning mirror 504 and directed through λ/4 wave plate 35 and onto micro-mirrors 50 of DMD chip 36. The λ/4 wave plate 35 is positioned between curved lens 34 and the DMD 36 to minimize polarization dependent loss (PDL) by compensating for the polarization response of the diffraction grating 30.

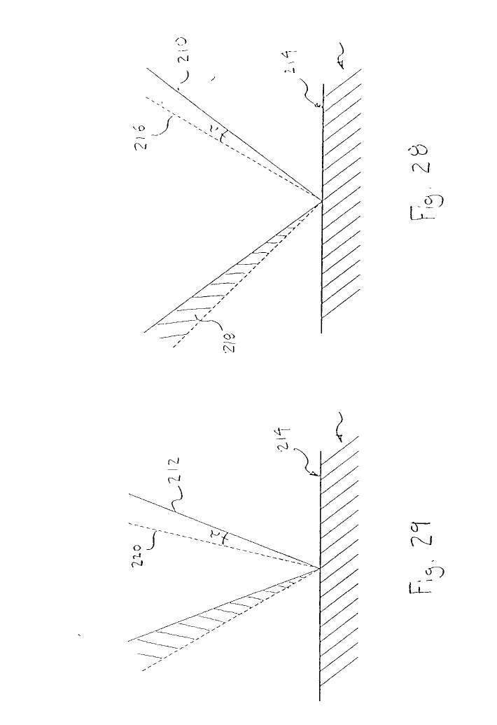

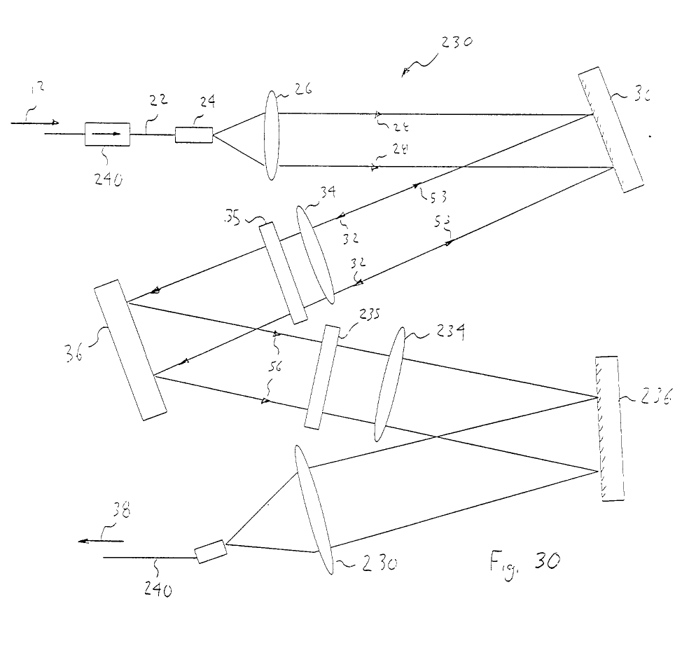

An example of a practical embodiment of DGEF 500 is best shown with reference to FIGS. 32, 33. In describing this particular embodiment element by element along the optical path DGEF 500 includes an input fiber 22 and output fiber 82 are combined with collimator lens 26 into a Beam Generating Module (BGM) 510 adjustably mounted within chassis 520. Diffraction grating 30 is disposed within adjustable mount 530 and is further mounted within chassis 520. Curved mirror or Fourier lens 132 is mounted to chassis 520 on adjustable mount 540. Turning mirror 504 is similarly mounted in an adjustable mirror mount 550 within chassis 520 directly above λ/4 wave plate 35, which is rotatably mounted within the chassis as well. Chassis 520 is comprised of an aluminum alloy material. One will appreciated that the various elements of DGEF require precise machining and/or adjustability to provide for optical alignment and channel equalization performance across a wide temperature and vibration, among other elements, operating environment.

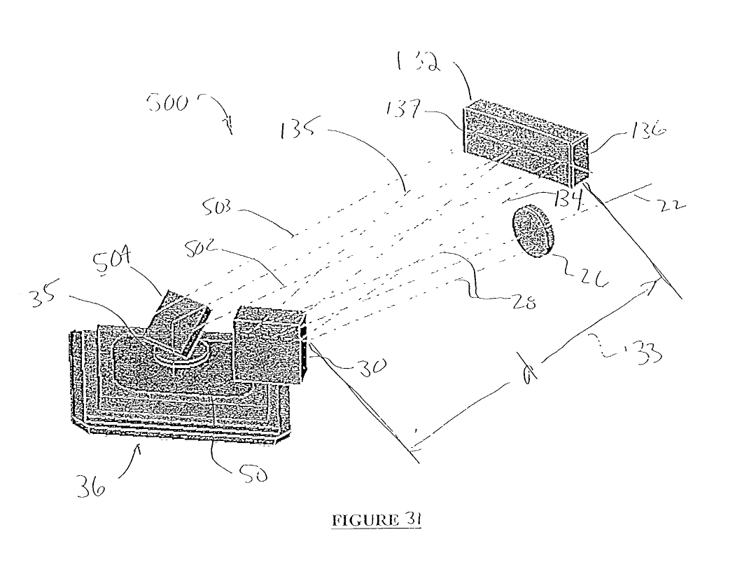

Referring to FIGS. 34 and 35 there is shown in detail the Beam Generation Module (BGM) 510 of the present invention. BGM 510 is responsible for alignment and focus of the input beam and is comprised of basic mount 515 made of a titanium alloy and includes a fine thread drive 511 for fine focus adjustment a flexure portion 512 for further focusing and a flexure block 513 for transverse and longitudinal fiber alignment functions. Also included in the BGM is a dual fiber holder ball clamp 516 for holding fibers 22, 82 attached to mounting block 517 which is further attached to flexure block 513. The BGM further includes an aluminum, temperature compensation rod 518 positioned within the flexure portion 512 to compensate for thermal growth that may otherwise degrade optical alignment.

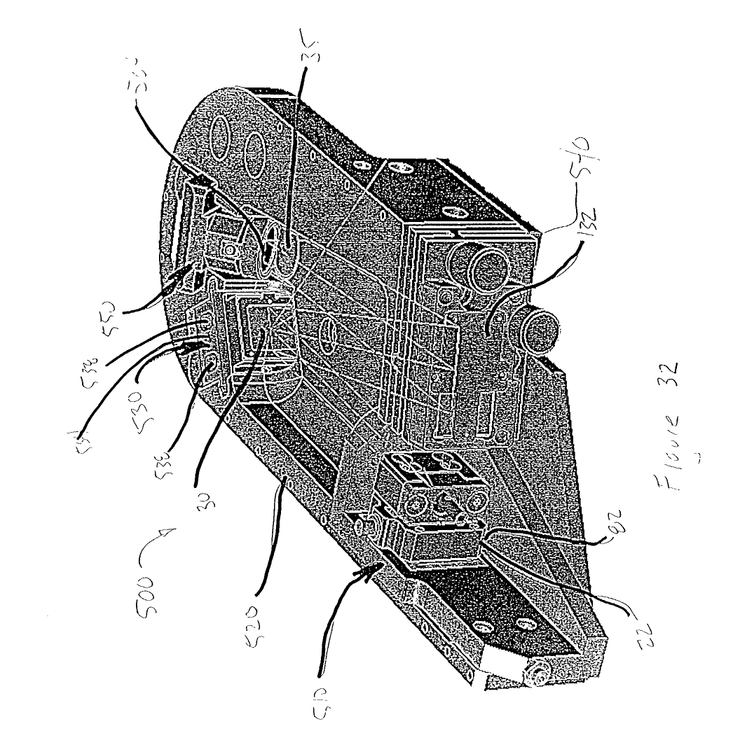

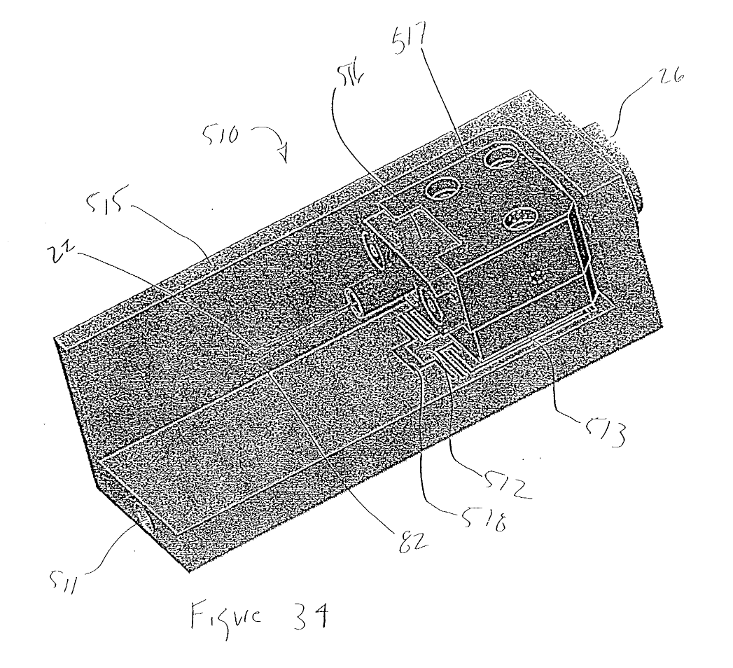

Referring to FIG. 36 there is shown in detail the curved mirror mount 540 of chassis 520. The chassis 520 is comprised of an aluminum alloy material and mirror mount 540 is machined therein and provides two axis adjustment of the curved lens 132. One will appreciate that the rotation of a screw 526, 527 (FIG. 40) within threaded holes 522, 523 effects alignment along axes 524, 525 respectively.

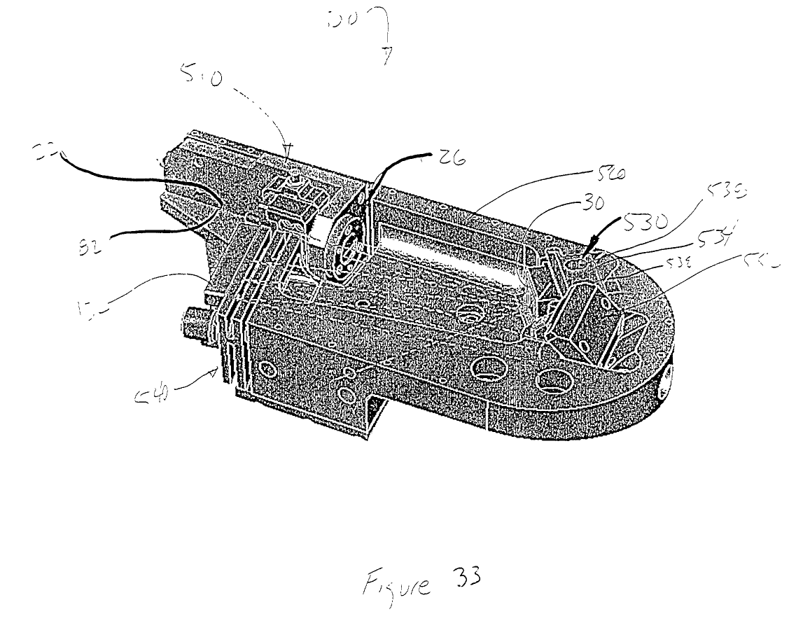

Referring to FIGS. 37 and 38 there is shown in detail the diffraction grating mount 530 including frame 531, front 532, backing plate 533 and clamp 534 (FIG. 27). The various parts of diffraction grating mount 530, specifically the three ball mounts 535, 536, 537 of front 532 cooperate to fixedly position the diffraction grating 30 without undue optical distortion from mounting stresses. The frame 531, front 532 and backing plate 533 are comprised of a stainless steel alloy and clamp 34 is comprised of an aluminum alloy. Clamp 34 further includes slots 538 for optically aligning the diffraction grating 30 within the chassis.

Referring next to FIG. 39 there is shown in detail the adjustable turning mirror mount 550 including ring 551 and mount 552 which cooperate to fixedly position the turning mirror 504 without undue optical distortion from mounting stresses. The ring 551 is comprised of an aluminum alloy and the mount is comprised of titanium, front 532 and backing plate 533 are comprised of a stainless steel alloy and clamp 34 is comprised of. Clamp 34 further includes slots 538 for optically aligning the diffraction grating 30 within the chassis.

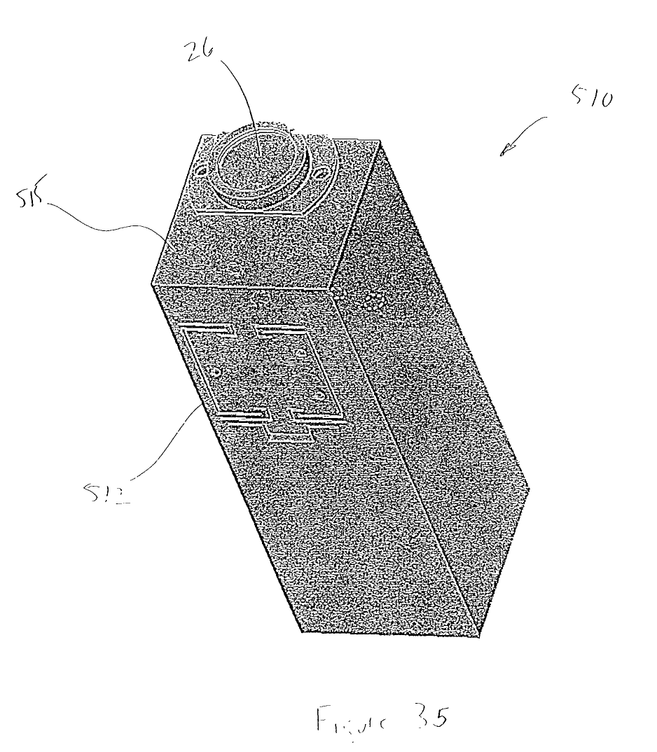

Referring next FIGS. 40 and 41 there is shown the relationship and attachment of the DMD chip and board assembly 570 to the chassis 520 of DGEF 500. The assembly 570 is mounted to the chassis 520 via bolts 571 into threaded holes in the chassis including standoffs 572 mounted therebetween. DGEF 500 further includes completion plate 575 mounted to chassis 520. Completion plate 575 stiffens the overall structure of the DGEF enhancing the optical stability thereof. In addition, one mode of adjustment of BGE 515 is accomplished by flexing the chassis 520 including the BGM relative to the bulk diffraction grating and then fixing the position thereof by tightening bolts within slots 576 of completion plate 575.

FIG. 42 illustrates a schematic diagram of another embodiment of a dynamic optical filter 600 that provides improved sensitivity to tilt, alignment, shock, temperature variations and packaging profile. Similar to the filters described hereinbefore, the filter 600 includes a dual fiber pigtail 601 (circulator free operation), a collimating lens 26, a bulk diffraction grating 30, a Fourier lens 34, a λ/4 wave plate 35 and a spatial light modulator 100 (similar to that shown in FIG. 14). The dual fiber pigtail includes a transmit fiber 603 and a receive fiber 605.

As shown, the filter 600 further includes a telescope 602 having a pair of cylindrical lens that are spaced a desired focal length. The telescope functions as a spatial beam expander that expands the input beam (approximately two times) in the spectral plane to spread the collimated beam onto a greater number of lines of the diffraction grating. The telescope may be calibrated to provide the desired degree of beam expansion. The telescope advantageously provides the proper optical resolution, permits the package thickness to be relatively small, and adds design flexibility.

Additionally, the optical filter 600 includes a chisel prism 604 (“CP”) that decreases the sensitivity of the optical filter to angular tilts of the optics. The insensitivity to tilt provides a more rugged and robust device to shock vibration and temperature changes. Further, the chisel prism provides greater tolerance in the alignment and assembly of the optical filter, as well as reduces the packaging profile of the filter. To compensate for phase delay associated with each of the total internal reflection (“TIR”) of the reflective surfaces of the prism (which will be described in greater detail hereinafter), a λ/9 wave plate 606 is optically disposed between the prism 604 and the λ/4 wave plate 35. An optical wedge or lens 608 is optically disposed between the λ/4 wave plate 35 and the diffraction grating 30 for directing the output beam from the micro-mirror device 100 to the receive pigtail 605 of the dual fiber pigtail 601. The wedge compensates for pigtail and prism tolerances.

A folding mirror 611 is disposed optically between the Fourier lens and the λ/4 wave plate 35 to reduce the packaging size of the optical filter 600.

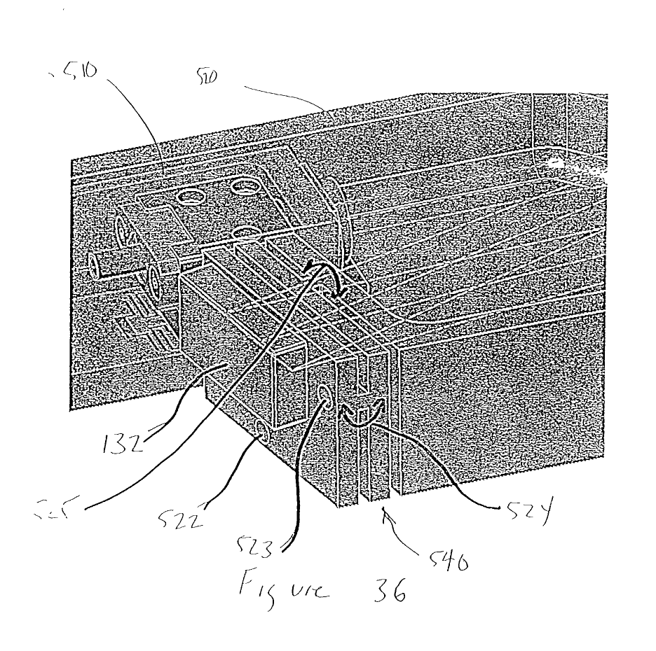

As suggested hereinbefore, a recurring problem in optics is the ability to send a collimated beam out to a reflective object and return it in manner that is insensitive to the exact angular placement of the reflective object. Because the beam is collimated and spread out over a relatively large number of micromirrors, any overall tilt of the array causes the returned beam to “miss” the receive pigtail. FIG. 43 illustrates the basic problem, which shows only the relevant portion of the optical system of the DGEF 600 and leaves out the grating 30 and Fourier lens 34 for clarity purposes. As shown, a point source or transmit fiber 603 (such as radiation emitted from a single-mode optical fiber) is collimated with the lens 26 and reflected off a remote object. In this case the object is a simple mirror 612 (or micromirror device 100). If the mirror 612 is not aligned very carefully with respect to the collimated beam 614, the return beam 616 will miss the receive pigtail 605. The receive pigtail 605 in FIG. 43 is the same as the transmit fiber 603, but of course the receiver can be a separate fiber behind the collimating lens 26, or another lens/fiber combination located essentially anywhere in space.

To illustrate just how sensitive the returned power is to reflector alignment in FIG. 43, consider the following example. Assume the collimating lens 26 has a focal length of 10 mm, the light emitted from the fiber 603 has a Gaussian radius of 5 um at a wavelength of 1.55 um. The radius of the collimated beam 614 is then approximately 1 mm, which provides a beam divergence of the collimated beam of about 0.5 milliradian. Displacing one end of a 2 mm reflector 612 by a mere 1 um would induce more than 4 dB of excess insertion loss from a displacement δ_{R} at the receiver 614 of about 5 um.

In the above example, the tilt sensitivity is directly related to the divergence angle of the collimated beam 614. By custom tailoring the reflective assembly, the reflected beam can have a predetermined pointing difference from the incident beam, allowing the use of a separate transmit and receiver fiber 603,605 before the collimating lens 26.

One possible way to reduce the tilt sensitivity of the reflector 612 would be to focus on the reflector. This has several inherent draw-backs, however. First, the size of the beam 614 is generally quite small on the reflector 612, which may be disadvantageous when the beam footprint must span many pixels of a spatial light modulator. Second, since the beam 614 comes to a focus, the beam size on the reflector 612 changes quickly as the reflector is moved with respect to the collimating lens (distance “d” in FIG. 43.)

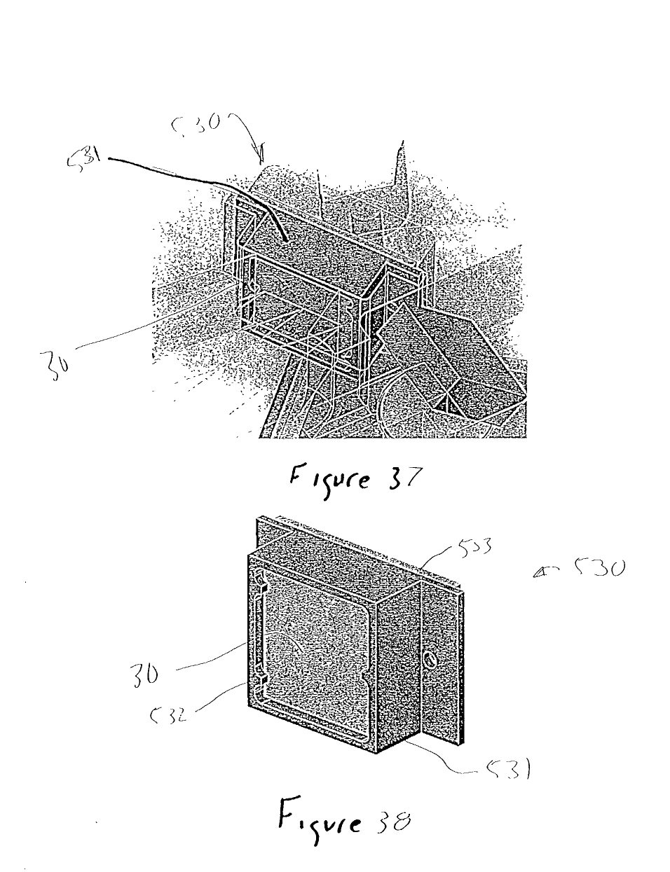

In the above example, the main optical problem is that the tilt error of the mirror 612 causes a deviation in the reflected angle of the light from the input path. There are other combinations of surfaces that do not lead to this condition. It is well known from classical optical design that certain combinations of reflective surfaces stabilize the reflected beam angle with respect to angular placement of the reflector. Examples are corner-cubes (which stabilize both pitch and yaw angular errors) and dihedral prisms (which stabilize only one angular axis.). FIG. 44 illustrates a dihedral reflective assembly 618.

These “retro-reflective assemblies” work on basically the same principal: All the surfaces of the objects are stable relative to one another, but the overall assembly of the surfaces may be tilted without causing a deviation in reflected angle of the beam that is large compared to the divergence angle of the input beam. Tilting the assembly causes primarily an overall displacement (δ_{d}) of the reflected beam, which causes a change in angle into the receiver θ_{R} as shown in FIG. 44. In many cases the beam is inherently quite small at the receiver so the received power is relatively robust to angular changes θ_{R}.

A “well engineered” design must trade off the far-field beam size (large beam sizes allow for large physical δ_{d} but put high tolerances on the stability of the reflective assembly 618) and focal length and focal distance of the collimating lens 26. Conversely, small collimated beam sizes reduce the tolerances on the lens focal distance and relative stability of the retro-reflective object surfaces 618, but lead to larger angular errors δ_{R} (and hence larger power losses) as a function of assembly tilt θ_{T}.

It is also well known that retro-reflective assemblies may be comprised of sets of mirrors attached to a stable sub-frame. In the case where angular stabilization is only needed for one angular axis, an even number of surfaces is used in the reflective assembly.

The optical filter 600 has a retro-reflective assembly 616 having an even number of reflective surfaces to provide angular stability. The retro-reflective assembly includes the chisel prism 604 and the micro-mirror device 100, which provides one of the reflective surfaces of the retro-reflective optical assembly 616. One advantage of this configuration is to remove the tilt sensitivity of the optical system (which may comprise many elements besides a simple collimating lens 26) leading up to the retro-reflective spatial light modulator 100 assembly. This configuration allows large beam sizes on the spatial light modulator without the severe angular alignment sensitivities that would normally be seen.

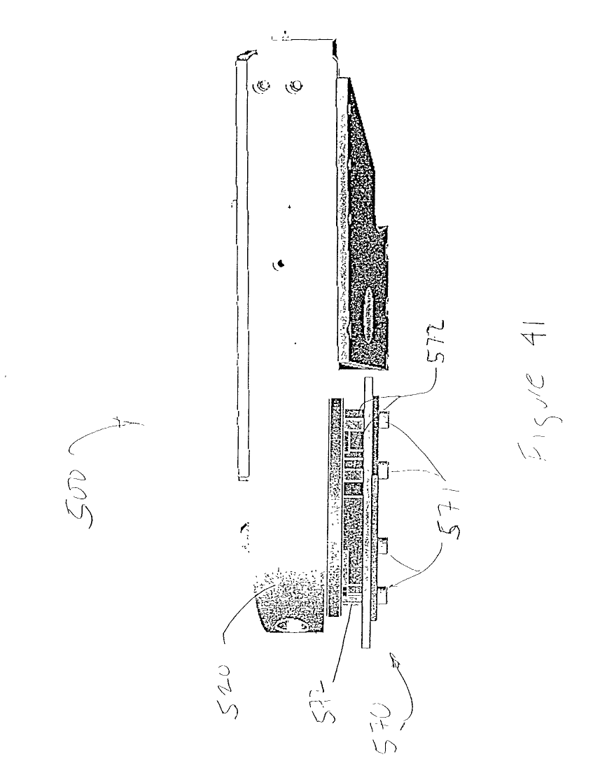

FIG. 45 shows a perspective view of an embodiment of the chisel-shaped prism 604 that is use in combination with a spatial light modulator 100, such as a spatial light modulator manufactured by Texas Instruments (referenced hereinbefore and similar to that in FIG. 14) to provide the retro-reflection assembly. The prism 604 has two total internally reflecting (TIR) surfaces (the top surface 620 and back surface 622), and two transmissive surfaces (the front surface 624 and the bottom surface 626). The micro-mirror device 100 is placed normal to the bottom surface 626, as best shown in FIGS. 45 and 47.

FIG. 47 shows a practical embodiment of a tilt-insensitive reflective assembly 616 comprising the specially shaped prism 604 (referred as a “chisel prism”) and a micro-mirror device 100. Unlike an ordinary 45 degree total internal reflection (TIR) prism, in one embodiment the back surface of the prism is cut at approximately a 48 degree angle 621 relative to the bottom surface 626. The top surface is cut at a 4 degree angle 623 relative to the bottom surface to cause the light to reflect off the top surface via total internal reflection. The front surface 620 is cut at a 90 degree angle relative to the bottom surface. The retro-reflection assembly therefore provides a total of 4 surface reflections in the optical assembly (two TIRs off the back surface 622, one TIR off the micromirror device 100, and one TIR off the top surface 620.)

In order to remove the manufacturing tolerances of the prism angles, a second small prism (or wedge), having a front surface 625 cut at a shallow angle 631 (e.g., as 10 degrees) with respect to a back surface 627, is used. Slight tilting or pivoting about a pivot point 629 of the compensation wedge 608 causes the beam to be pointed in the correct direction for focusing on the receive pigtail 603.

The combination of the retro-reflective assembly 616 and compensation wedge 608 allows for practical fabrication of optical devices that spread a beam out over a significant area and therefore onto a plurality of micromirrors, while keeping the optical system robust to tilt errors introduced by vibration or thermal variations.

Referring to FIG. 47, the input light rays 614 first pass through the λ/4 wave plate 35 and the λ/9 wave plate 606. The input rays 612 reflect off the back surface 622 of the prism 604 to the micro-mirror device 100. The rays 616 then reflect off the micromirror device 100 back to the back surface 622 of the prism 620. The rays 616 then reflect off the top surface 620 for a total of 4 surfaces (an even number) and passes through the front surface 624 of the prism. The rays 616 then pass back through the λ/4 wave plate 35 and the λ/9 wave plate 606 to the wedge 608. The wedge redirects the output rays 616 to the receive pigtail 603 of the dual fiber pigtails 601 of FIGS. 42 and 45. As shown by arrows 626, the wedge 608 may be pivoted about its long axis 629 during assembly to slightly steer the output beam 616 to the receive pigtail 603 with minimal optical loss by removing manufacturing tolerances of the chisel prism.

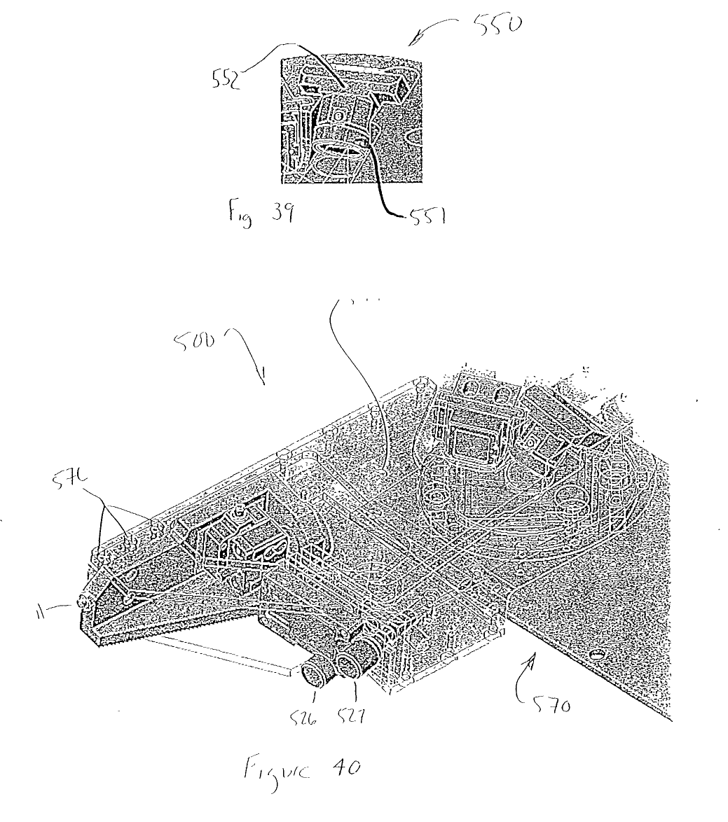

Referring to FIG. 46, the prism 604 (with wave plates 35,606 mounted thereto) and the micro-mirror device 100 are mounted or secured in fixed relations to each other. The prism and micro-mirror device are tilted a predetermined angle θₚ off the axis of the input beam 614 (e.g., approximately 9.2 degrees) to properly direct the input beam onto the micromirrors of the micromirror device, as described hereinbefore. The wedge 608 however is perpendicular to the axis of the input beam 614. Consequently, the receive pigtail 605 of the dual fiber pigtail 601 is rotated a predetermined angle (approximately 3 degrees) from a vertically aligned position with the transmit pigtail 603. Alternatively, the wedge may be rotated by the same predetermined angle as the prism and the micromirror device (e.g., approximately 9.2 degrees) from the axis of the input beam. As a result, the receive pigtail 605 of the dual pigtail assembly 601 may remain vertically aligned with transmit pigtail 603.

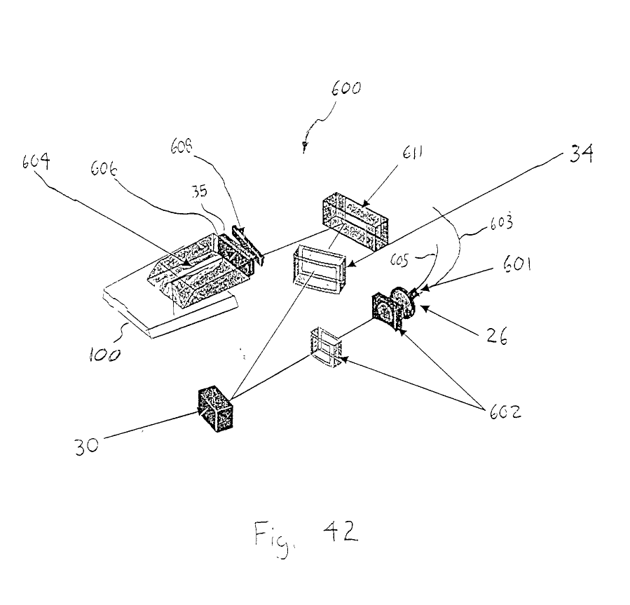

FIG. 48 illustrates to scale the channel layout and spacing of four optical channels of a WDM input signal onto the array of micromirrors of a micromirror device 100, similar to that described in FIGS. 14 and 21. The channels are substantially elliptical in shape and are disposed diagonally over the array of micromirrors. Note that only a intermediate portion of each of the optical channels is shown. The center of each channel is indicated by the axes c₁-c₄. In the example shown, the width of each channel W₁-W₄ is approximately equal and is approximately twice the spacing of the peaks of each of the optical channels. Consequently, the channels overlap spectrally. The left and right neighboring channels of any given channel have their 1/e² intensity point at the center of the given channel, as best shown in FIG. 49.

In one embodiment, the pitch of the micromirrors is 13.8 um (or a diagonal pitch of 19.4 um). The diagonal pitch of 19.4 um, which is disposed in the spectral direction 55, corresponds to a spacing of the light at the input pigtail 603 of 300 pm. In other words, input light spaced by 300 pm (or 0.3 nm) disperses or separates the input light imaged onto the micromirror device 100 by 19.4 um. For example, for an input signal having 50 Ghz spacing set by the ITU grid, which has channel spacings of approximately 0.4 nm, the spacing of the channels imaged onto the micromirror device is approximately 25.9 um. Consequently, the spacing of the channels imaged on the micromirror device is approximately 13 um. This relationship between the spacing of the channels imaged on the micromirror device and the spacing of the light at the input pigtail 603 is set by the optical design.

FIG. 49 is a plot of the intensity of the optical channels of spectral channel layout of FIG. 48 taken along line 49-49 that illustrates four adjacent unmodulated channels on a 50 GHz (0.4 nm) spacing.

As described hereinbefore, the micromirror device 100 is rotated 45 degrees such that the pivot axis 51 is perpendicular to the spectral axis 55, as shown in FIG. 48. Alternatively, the micromirror device 100 may be rotated 45 degrees such that the pivot axis is parallel to the spectral axis 55. While this alternative is a possible embodiment of the present invention, this orientation causes substantial loss versus wavelength.

FIG. 50 illustrates the cause of the substantial loss resulting from pivoting the micromirrors 52 parallel to the spectral direction 55. Consequently, the micromirror device 100 is tilted at a predetermined angle α(e.g. 10 degrees) in the spatial plane 53. As a result, a deviation angle α_{d} of the reflected light (i.e., shorter and longer wavelengths) is introduced that causes a wavelength dependant loss.

In contrast as shown in FIG. 50, the micromirrors 52 of the micromirror device 100 pivot perpendicular to the spectral direction 55. Consequently, the micromirror device 100 is tilted at a predetermined angle α(e.g., 10 degrees) in the spectral plane as best shown in FIGS. 1 and 50. As a result, as shown in FIG. 50, the deviation angle α_{d} of the reflected light (i.e., shorter and longer wavelengths) is substantially zero such that a simple focal length shift (as shown in FIGS. 19a, 19b) may be performed to compensate for the grating characteristics of the micromirror device.

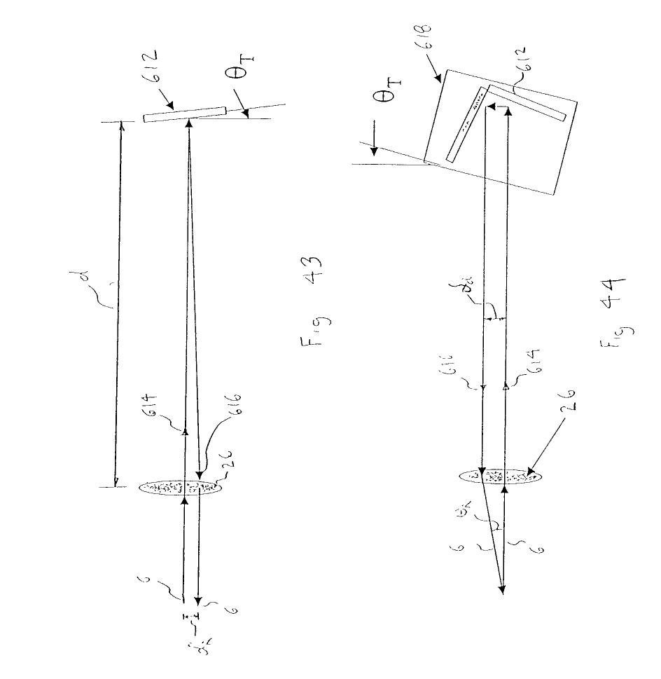

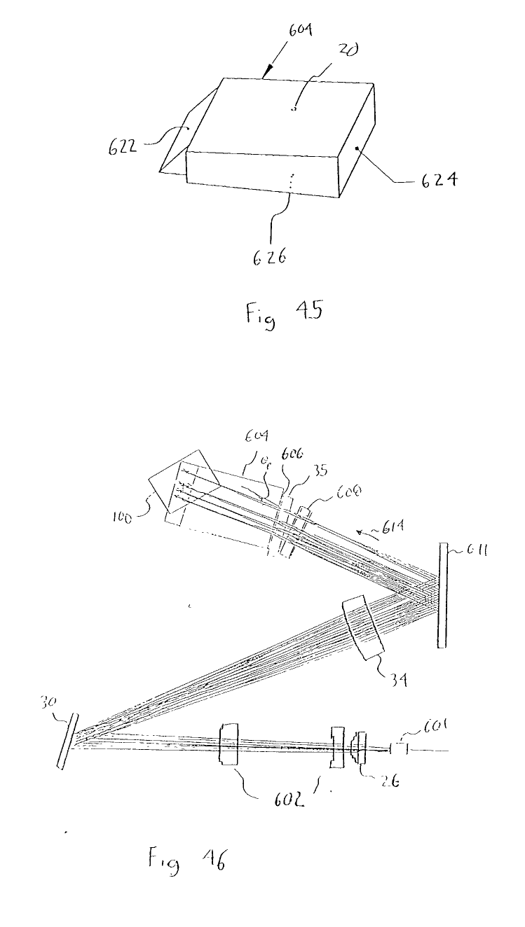

FIG. 52 illustrates power loss versus wavelength of the embodiments described in FIGS. 50 and 51 across the “C” band and “L” band. The embodiment, wherein the micromirrors 52 have a pivot axis 52 perpendicular to the spectral direction 55, has minimal wavelength dependant loss, while the other embodiment, wherein the micromirrors have a pivot axis parallel to the spectral direction, has excessive wavelength dependant loss. Without some mitigation, the embodiment of FIG. 50 may preclude “C” band and “L” band operation.

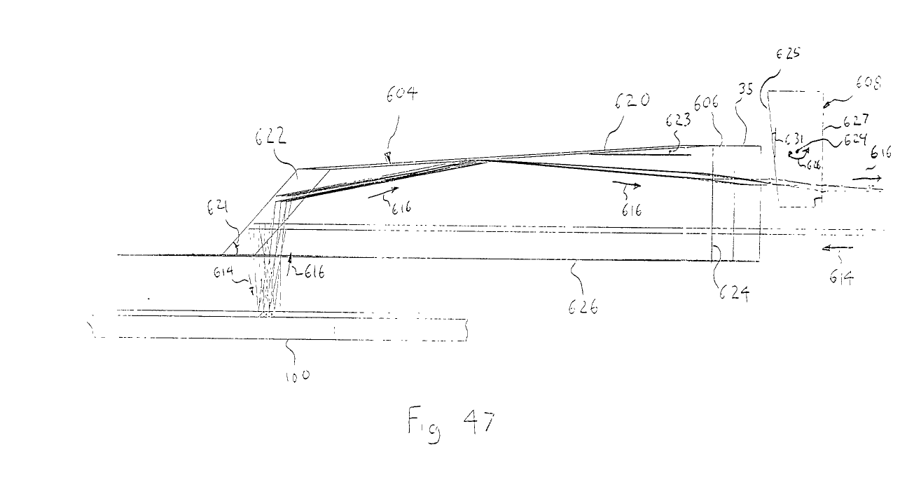

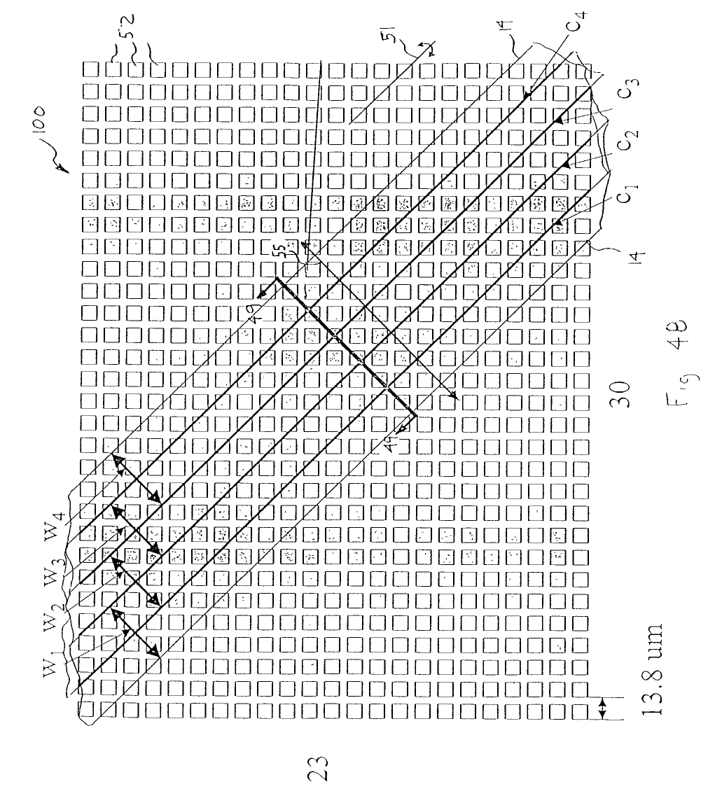

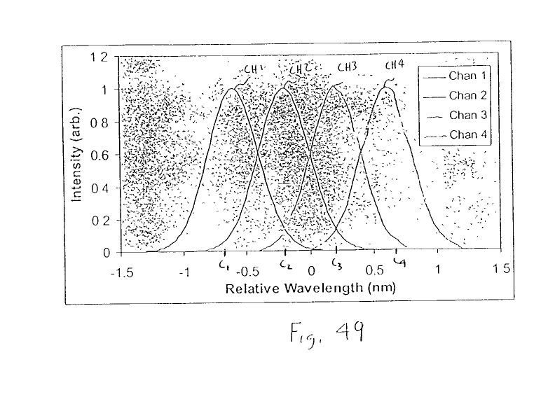

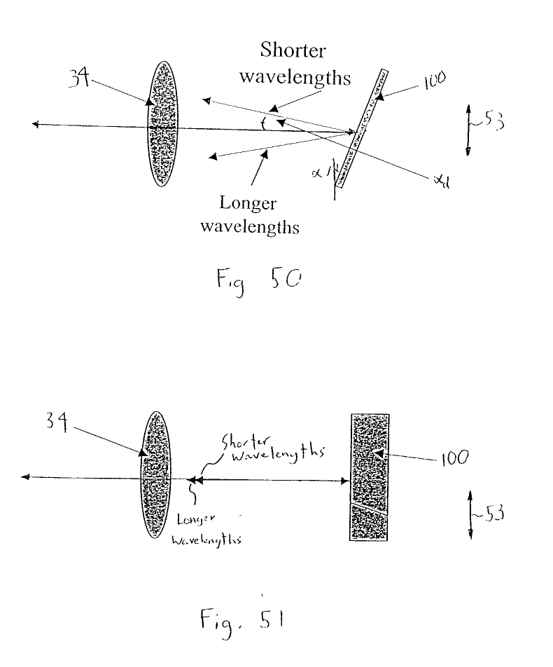

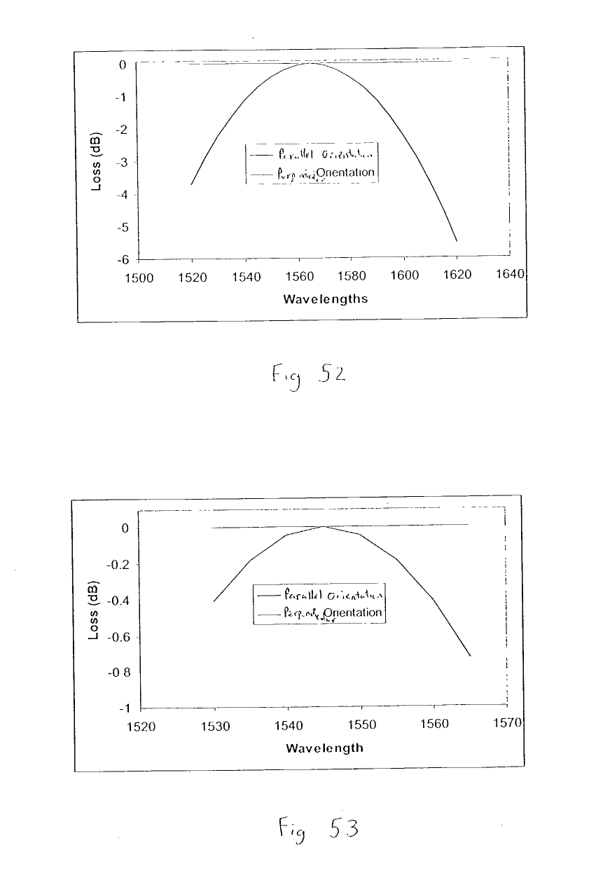

FIG. 53 illustrates power loss versus wavelength of the embodiments described in FIGS. 50 and 51 across only the “C” band. Similar to that shown in FIG. 52, the parallel orientation of the pivot axis 52 shows significant wavelength dependant loss, while the perpendicular orientation shows minimal loss.

FIGS. 54-63 illustrate the mechanical design of an optical filter 640, similar to the optical filter 600 described in FIGS. 42-49. FIG. 54 is a perspective view of the optical filter 640 that includes a DSE controller 641, a controller 58, a programmable gate array 642, a pair of optical couplers 644, an optical assembly 646, which includes the optics shown in FIG. 42. The processor communicates with the controller through an electrical connector 648. Referring to FIG. 90, the DSE controller 641 includes a data acquisition and control device for processing input from chassis temperature sensors and micromirror device (DMD) 50 temperature sensor. The data acquisition and control device further controls a thermoelectric device (TEC) to cool the micromirror device. The DSE controller further includes a laser for imaging a reference signal on the micromirror device and a photodiode for sensing the light reflecting back from the micromirror device, which provides and indication of movement of failure of the micromirror device. As shown, a programmable gate array (FPGA) controls the flipping of the micromirrors in response to an algorithm and input signal. ;

FIG. 55 illustrates the optical assembly 640 includes the optics mounted to an optical chassis 650. The chassis includes a plurality of isolators to provide shock absorbers. The optics include a dual pigtail assembly 601, a collimating lens 26, a telescope 602 (e.g., cylindrical lens), a diffraction grating 30, a Fourier lens 34, a fold mirror 611, a wedge 608, a zero order wave plate 35,606, a chisel prism 604 and micromirror device 100 (not shown).

FIGS. 56 and 57 show the Fourier lens 34 and lens mount or retaining clip 652 that provides kinematic mounting of the Fourier lens. The mount includes a pair of finger stock springs 654 that urge the lens 34 upward against three posts disposed in the upper wall of the retaining spring 652. The mount further includes a pair of leaf springs 656 that urge the lens rearward against 3 posts or protrusions disposed in the rear wall of the clip. The mount is adjustable to the chassis to permit adjustment of the focal length before being welded thereto.

FIG. 58 shows the mounting mechanism for mounting the chisel prism 604 and the wedge 608 to the optical chassis 605. The wedge is mounted to a rod the passes through a bore in the chassis. The rod permits the wedge to be rotated about its longitudinal axis during assembly to align the retro-reflected light to the receive pigtail 605 (not shown), whereinafter the rod is secured to the chassis, such as by welding. The prism is secured to the chassis by a 6 point mount that include a retaining clip 660 and a pair of plungers 662.

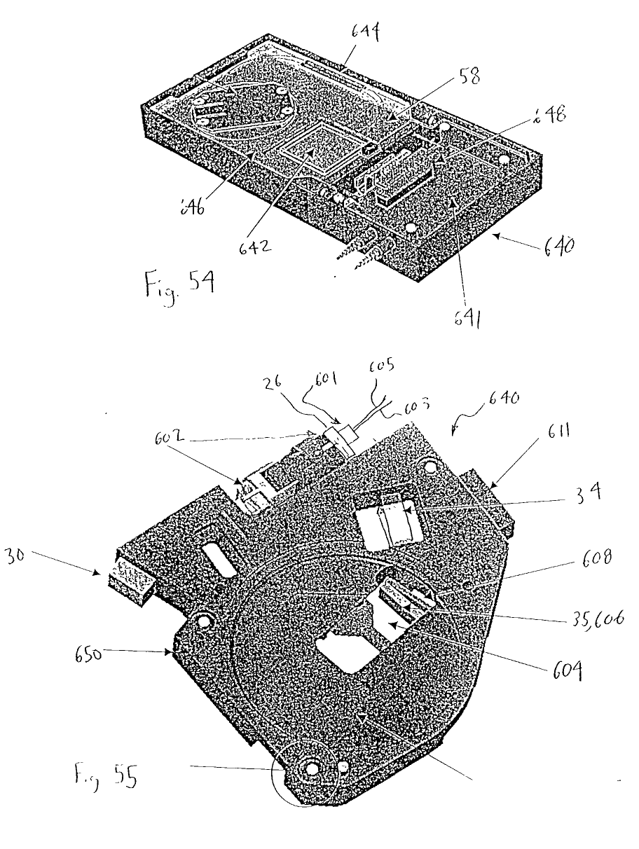

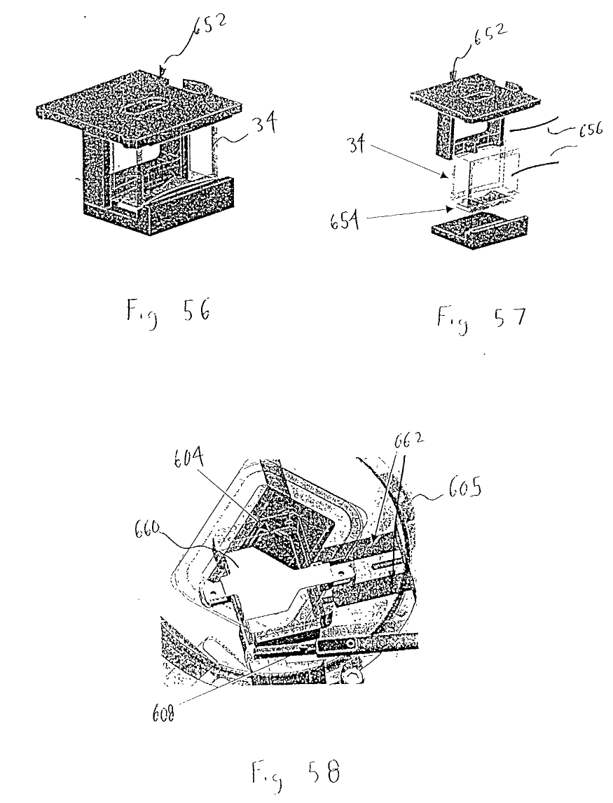

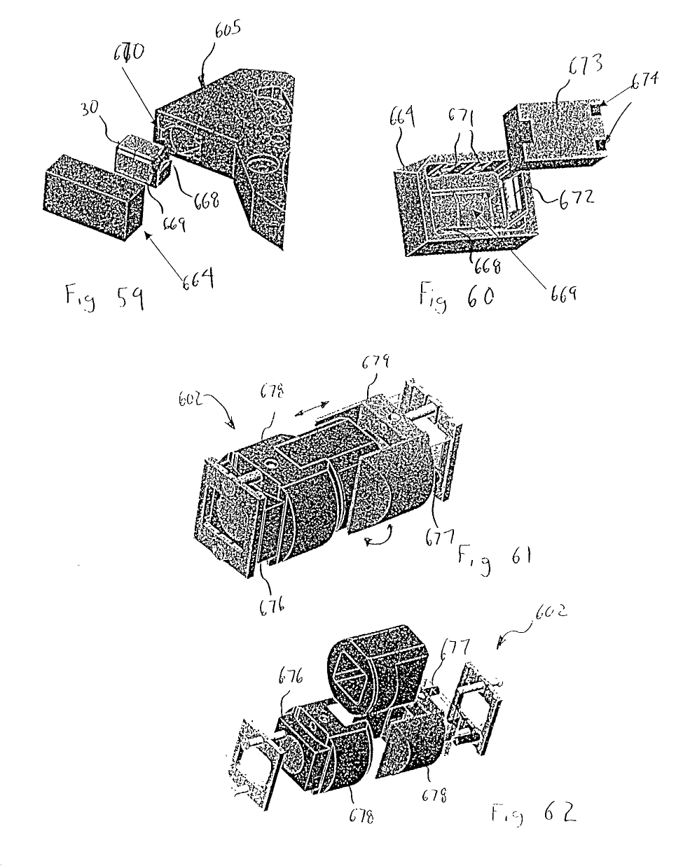

FIGS. 59 and 60 show the diffraction grating 30 and grating mount 664 that provides kinematic mounting of the grating. The grating is disposed in the grating mount that includes two sets of finger stock springs 668,669 that urge grating against three tabs 670 disposed in the chassis and the protrusions 671 disposed in the upper wall of the mount 664. Further, a finger stock 672 is dispose in one side of the mount for urging the grating against the opposing side wall of the mount. The front surface 673 of the grating is ablated to remove the epoxy at 674 to provide a hard surface to engage the tabs 670 disposed in the chassis 605.

FIGS. 61 and 62 illustrate the telescope 602 that includes a pair of lens 676,677 mounted to a pair of submounts 678,679. An intermediate component permits the focal length of the pair of lens 676,677 and the rotational orientation therebetween to be adjusted off chassis. After being adjusted, the telescope can then be welded or otherwise secured to the chassis.

FIG. 63 shows a cross-section view of the collimating lens 26 that includes the dual fiber pigtail assembly 601 disposed therein. Similar to the telescope 602, the lens portion 680 may be rotated relative to the pigtail assembly 601 and the focal length therebetween adjusted.

While the optical filter 10,600 embodying the present invention described hereinabove illustrate a single device using a set of optical components, it would be advantageous to provide an embodiment including a plurality of optical filters that uses a substantial number of common optical components, including the spatial light modulator. Such an embodiment includes a complementary set of input pigtails 17,27 spatially displaced from the first set of input pigtails, and a complementary output pigtail 82 spatially displaced from the first output pigtail. The light passing to and from the input and output pigtails propagate and reflect off the same optics.

To provide a plurality of optical filters (Filter₁, Filter₂) using similar components, each optical filter uses a different portion of the micromirror device 36, as shown in FIG. 64, which is accomplished by displacing spatially the second set of input and output pigtails. As shown, the channels 14 of each filter is displaced a predetermined distance in the spatial axis 53. While a pair of optical filters is shown in FIG. 64, one will recognize that another embodiment of the present invention has N number of filters using substantially the same optical components, as described hereinabove.

As shown in FIGS. 65-67, an optical filter, generally shown as 700, is programmable to selectively provide a desired filter function for filtering an optical WDM input signal 12 in network applications, for example. The flexible optical filter includes a micromirror device similar to the DGEF shown in FIGS. 1-64, which is described in great detail hereinafter. In fact the configuration of the flexible optical filter 700 is substantially the same as the DGEF described hereinafter. The digital signal processor (DSP) (see FIG. 77) of the controller 58 or DSE controller of optical filter 700 is programmable to provide any desirable filter function in response to control signal 702 at input 704. Alternatively, the DSP may be programmed to provide the desired filter function. The control signal is provided to the controller 58 (see FIG. 2) of the micromirror device 36. In response to the control signal 702, the controller 58 flips the appropriate mirror or mirrors 52 to provide the desired filter function.

For example as shown in FIG. 65, the optical filter 702 may selectively attenuate selected optical channel(s) of an input signal 706 to flatten or equalize each of the input channels to provide an equalized output signal 708, as described hereinafter in FIGS. 1-64.

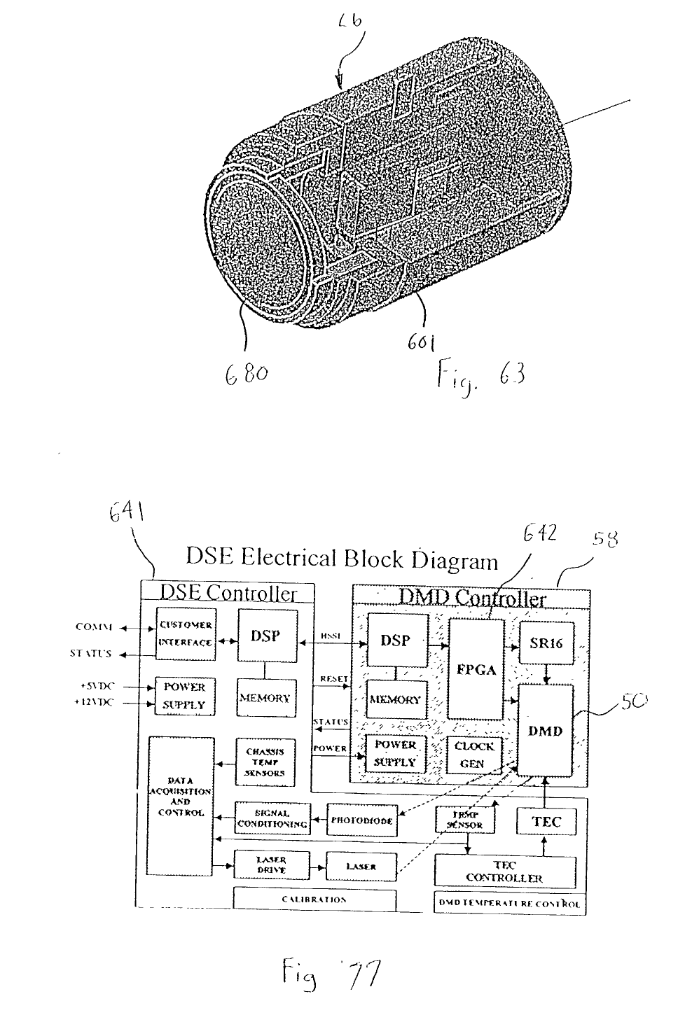

As shown in FIG. 66, the optical filter 700 may be reconfigured to function as an optical drop device. A WDM input signal 710 is provided at the input port 712. In response to the control signal 702, the micromirrors 52 are flipped to redirect or drop a selected optical channel 714. In the alternative, the optical filter 710 may be configured to drop a band of optical channels 716. The present invention also contemplates dropping any combination of channels.

As shown in FIG. 67, the optical filter 700 may be reconfigured to function as an optical spectral analyzer (OSA) functioning in the scan mode. A WDM input signal 710 is provided at the input port 712. In response to the control signal 702, the micromirrors 52 are dynamically flipped to sequentially drop each of the input optical channels at the output port 720. The output may then be provided to an optical detector (not shown) to measure and determine various optical characteristics of the input signal. This configuration is also similar to the optical channel monitor (OCM) of copending U.S. Provisional Patent Application Serial No. (Cidra Docket No. CC-0396), which is incorporated herein by reference.

In this scanning mode one will also appreciate that as the filter function scans the spectrum of the input signal, the bandwidth may be varied to provide data to measure the optical signal-to-noise (OSNR) of the input signal or channels, as described in U.S. Provisional Patent Application Serial No. (CC-0369), which is incorporated herein by reference. For instance, a filter function having a wide bandwidth is used to measure the power of an optical channel, while a filter function having a narrow bandwidth is used to measure the noise level between the optical channels.

One will also appreciate that the optical filter may also be commanded to flip the micromirrors 52 to provide a bandstop, bandpass or notch filter function.

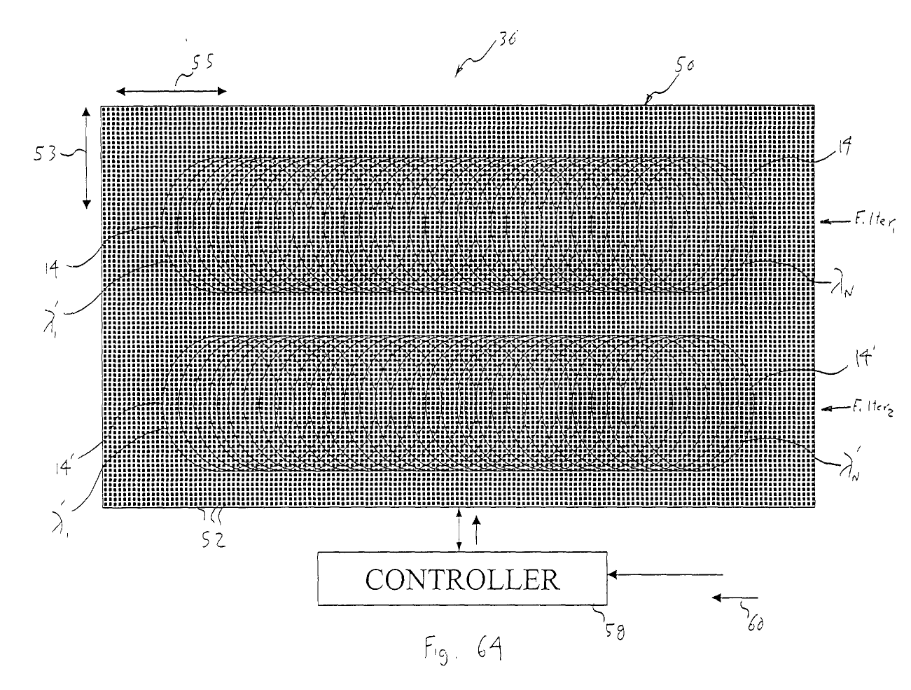

As shown in FIG. 68, the optical filter 730 provides a pair of output ports 732,733, which is similar to the reconfigurable optical add/drop multiplexer (ROADM) described in U.S. Provisional Patent Application No. (CC-0381), which is incorporated herein by reference. In response to the control signal 702, the optical filter 730 drops a channel or group of channels to one output port 732, and redirects the other output signals to the second port 734. One will appreciate that the two-port optical filter 730 may be configured to function as the optical filters in FIGS. 65-67.

As shown in FIG. 69, the optical filter 730 provides a pair of output ports 732, 733, which is similar to the optical interleaver/deinterleaver (ROADM) described in U.S. Provisional Patent Application Serial No. (CC-0397), which is incorporated herein by reference. In response to the control signal 702, the optical filter 730 drops all the odd channels one output port 732, and redirects all the even output signals to the second port 734. One will appreciate that the two-port optical filter 740 may be configured to function as the optical filters in FIGS. 65-67.

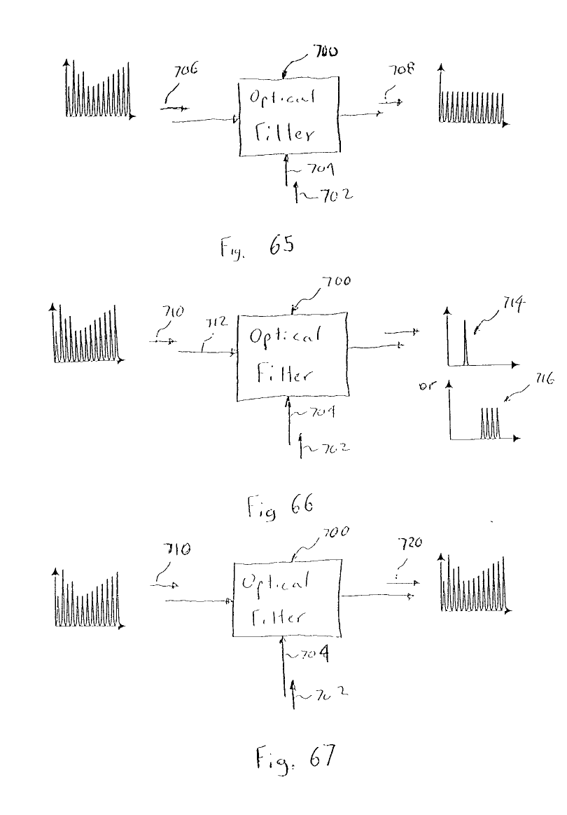

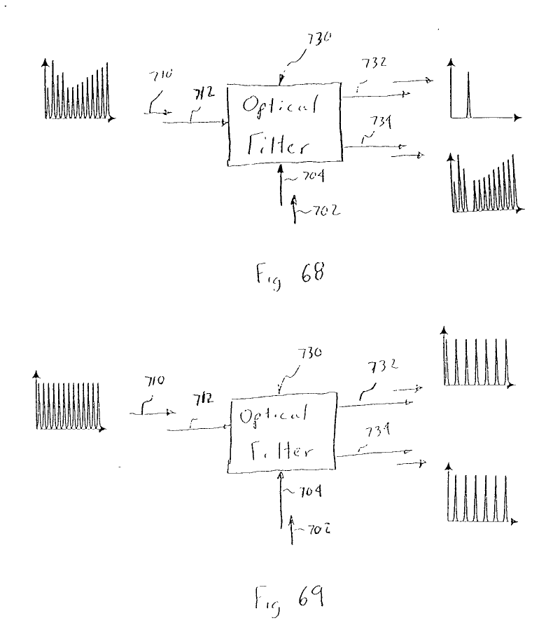

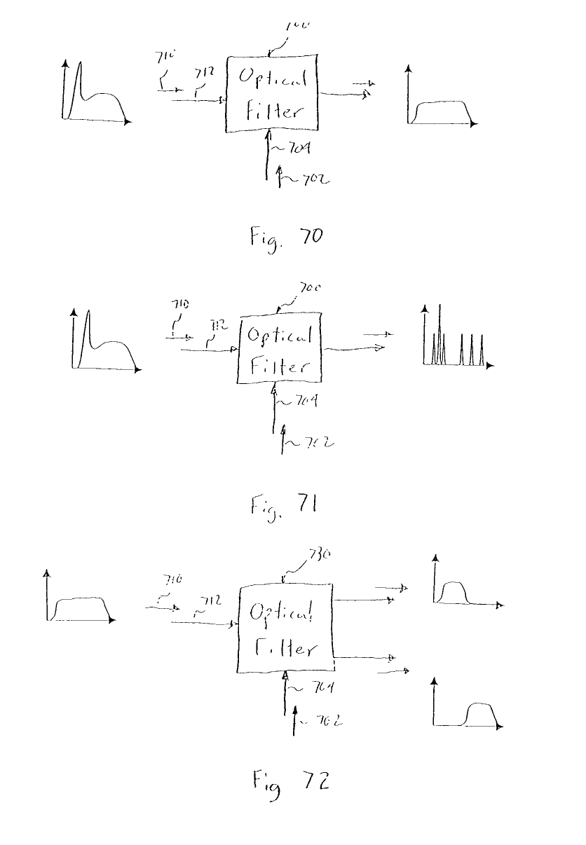

The optical filter may be configured in response to the control signal to function in laboratory and/or development applications. In FIG. 70, the optical filter 700 may be programmed to function as an amplifier gain flattening filter.

In FIG. 71, the optical filter 700 may be configured to function as a variable optical source.

In FIG. 72, the optical filter 720, 730, having a pair of output ports 732, 734, may function as a programmable edge filter.

The optical filters 700, 720, 730 may also be configured to provide a variable or selectable filter shape, such as sawtooth, ramp and square. The optical filters 720, 730 may also be configured to tap off selected portions of the input signals at one output port and pass the remaining portions of the input signal through the second output port.

One will appreciate that the optical filter contemplated by the present invention enable innumerable filter functions to be programmed using the same hardware.

Although the invention has been described as using an array of digital micro-mirrors to implement the pixelating device in the embodiments shown herein, it should be understood by those skilled in the art that any pixelating device that provides pixelated optical signal processing may be used, as described further below. Further, instead of using micro-mirrors with two reflective states or angles of reflection (e.g., +/−10 deg) as a pixel that reflects a portion of the light beam, the pixels may have one reflective state and the other state may be absorptive or transmissive. Alternatively, instead of the pixel having at least one state being reflective (which may provide other design advantages), the pixel may have one state being transmissive and the other state being absorptive. Alternatively, the pixel may have two transmissive or partially transmissive states that refract the incoming light out at two different angles. For each of various pixelating devices, the optics surrounding the pixelating device would be changed as needed to provide the same functions as that described for each of the embodiments herein for the different type of pixelated optical signal processing used.

Also, instead of the pixels having a square, diamond or rectangular shape, the pixels may have any other two or three-dimensional shapes, i.e., circle, oval, sphere, cube, triangle, parallelogram, rhombus, trapezoid.

One pixelating device, for example, may include liquid crystal technology, such as a liquid crystal display (LCD). An LCD may provide a device having either one absorptive state and one reflective state, or one absorptive state and one transmissive state. The underlying principle of an LCD is the manipulation of polarized light (i.e., an optical channel). For example, the polarized light may be rotated by 90 degrees in one state of the liquid crystal and not rotated in another state. To provide an LCD having one absorptive state and one transmissive state, a polarizer is provided at each side of the liquid crystal, such that the polarization angles of the polarizers are offset by 90 degrees. A mirror can be added at one end to provide an LCD having one absorptive state and one reflective state.

One example of having a reflective state and a transmissive state is a variation on existing bubble jet technology currently produced by Agilent and Hewlett-Packard Co., and described in U.S. Pat. Nos. 6,160,928 and 5,699,462, respectively. In that case, when the bubble is in one state, it has total internal reflection; and when in the other state, it is totally transmissive. Also in that case, the pixels may not be square but circular or oval.

One example of having a transmissive state and an absorptive state is Heterojunction Acoustic Charge Transport (HACT) Spatial Light Modulator (SLM) technology, such as that described in U.S. Pat. No. 5,166,766, entitled “Thick Transparent Semiconductor Substrate, Heterojunction Acoustic Charge Transport Multiple Quantum Well Spatial Light Modulator”, Grudkowski et al and 5,158,420, entitled “Dual Medium Heterojunction Acoustic Charge Transport Multiple Quantum Well Spatial Light Modulator” to Grudkowski et al, provided the material used for the HACT SLM will operate at the desired operational wavelength. In that case, the pixels may be controlled by charge packets that travel along a surface acoustic wave that propagates along the device, where the size of the charge controls the optical absorption.

The dimensions and geometries for any of the embodiments described herein are merely for illustrative purposes and, as much, any other dimensions may be used if desired, depending on the application, size, performance, manufacturing requirements, or other factors, in view of the teachings herein.

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein without departing from the spirit and scope of the present invention.

What is claimed is:

1. A variable optical source, comprising:
a light dispersive element which receives an optical input signal having various wavelength channels of light, which provides a separated light signal having said wavelength channels spatially distributed by a predetermined amount;
a pixellating device, which receives said separated light, having a two dimensional array of pixels, each of said channels being incident on a plurality of pixels, each of said pixels having a first reflection state and a second reflection state in response to a pixel control signal, and said pixellating device providing a reflected separated light signal indicative of light provided from said first reflection state;
a light combining element, which receives said reflected separated light, recombines said reflected separated light, and provides an optical filter output signal indicative of a spectrally filtered optical input signal based on a filter function; and
a controller which generates said pixel control signal indicative of said filter function and wherein said filter function is selectable based on a desired spectral filter profile.

2. The apparatus of claim 1 wherein said pixelating device comprises a micro-mirror device and said pixels comprise micromirrors.

3. The apparatus of claim 1 wherein said filter function is: a band pass filter, a low pass filter, a band reject filter, or a high pass filter.

4. The apparatus of claim 1 wherein said filter function is a predetermined optical loss function.

5. The apparatus of claim 1 wherein said filter function changes dynamically over a predetermined time period.

6. The apparatus of claim 1 wherein said filter function changes continuously based on a predetermined filter change profile.

7. The apparatus of claim 1, wherein the light dispersive element comprises a diffraction grating.

8. The apparatus of claim 1, wherein the light dispersive element disperses the optical channels of the input light onto the pixellating device to substantially separate the optical channels on the pixellating device.

9. The apparatus of claim 1, wherein the light dispersive element disperses the optical channels of the input light onto the pixellating device to substantially overlap the optical channels on the pixellating device.

10. The apparatus of claim 1, wherein the cross-sectional area of at least one channel of said separated input light is generally circular in shape.

11. The apparatus of claim 1, wherein the cross-sectional area of at least one channel of said separated input light is generally elliptical in shape.

12. The apparatus of claim 1, wherein at least one optical channel of said input light is projected onto at least 50 micro-mirrors of said pixellating device.

13. The apparatus of claim 1, wherein micro-mirrors discretely switch from said first position to said second position.

14. A variable optical source, comprising:
a light dispersive element which receives an optical input signal having various wavelength channels of light, which provides a separated light signal having said wavelength channels spatially distributed by a predetermined amount;
a prism element, which receives said separated light having an incidence angle, and which provides a first stabilized light signal;
a pixellating device, which receives said first stabilized light, having a two dimensional array of pixels, each of said channels being incident on a plurality of said pixels, each of said pixels having a first reflection state and a second reflection state in response to a pixel control signal, and said pixellating device providing a reflected separated light signal indicative of light provided from said first reflection state to said prism element;
said prism element providing a second stabilized light signal in response to said reflected separated light signal, said second stabilized light being substantially independent of changes in said incidence angle of said separated light; and
a light combining element, which receives said second stabilized light signal, recombines said second stabilized light signal, and provides an optical filter output signal indicative of a spectrally filtered optical input signal based on a filter function.

15. The apparatus of claim 1 wherein said pixelating device comprises a micro-mirror device and said pixels comprise micromirrors.

16. The apparatus of claim 1 wherein said filter function is: a band pass filter, a low pass filter, a band reject filter, or a high pass filter.

17. The apparatus of claim 1 wherein said filter function is a predetermined optical loss function.

18. The apparatus of claim 1 wherein said output signal has a substantially flat spectral profile.

19. The apparatus of claim 1 wherein said filter function changes dynamically over a predetermined time period.

20. The apparatus of claim 1 wherein said filter function changes continuously based on a predetermined filter change profile.

21. The apparatus of claim 1, wherein the light dispersive element comprises a diffraction grating.

22. The apparatus of claim 1, wherein the light dispersive element disperses the optical channels of the input light onto the pixellating device to substantially separate the optical channels on the pixellating device.

23. The apparatus of claim 1, wherein the light dispersive element disperses the optical channels of the input light onto the pixellating device to substantially overlap the optical channels on the pixellating device.

24. The apparatus of claim 1, wherein the cross-sectional area of at least one channel of said separated input light is generally circular in shape.

25. The apparatus of claim 1, wherein the cross-sectional area of at least one channel of said separated input light is generally elliptical in shape.

26. The apparatus of claim 1, wherein at least one optical channel of said input light is projected onto at least 50 micro-mirrors of said pixellating device.

27. The apparatus of claim 1, wherein micro-mirrors discretely switch from said first position to said second position.

28. A variable optical source, comprising:
a light dispersive element which receives an optical input signal having various wavelength channels of light, which provides a separated light signal having said wavelength channels spatially distributed by a predetermined amount;
an optical lens, located a predetermined lens distance from said dispersive element and having a lens focal length, which receives said separated light, and which provides a focussed light signal;
a pixellating device, which receives said focussed light, having a two dimensional array of pixels, each of said channels being incident on a plurality of said pixels, each of said pixels having a first reflection state and a second reflection state in response to a pixel control signal, and said pixellating device providing a reflected separated light signal indicative of light provided from said first reflection state to said prism element;
a light combining element, which receives said reflected separated light signal, recombines said reflected separated light signal, and provides an optical filter output signal indicative of a spectrally filtered optical input signal based on a filter function; and
said lens distance being different from said focal length so as to provide a substantially constant optical loss over a predetermined wavelength range.

29. The apparatus of claim 1 wherein said pixelating device comprises a micro-mirror device and said pixels comprise micromirrors.

30. The apparatus of claim 1 wherein said lens distance is greater than said focal length.

31. The apparatus of claim 1 wherein said lens distance is less than said focal length.

32. The apparatus of claim 1 wherein said filter function is: a band pass filter, a low pass filter, a band reject filter, or a high pass filter.

33. The apparatus of claim 1 wherein said output signal has a substantially flat spectral profile.

34. The apparatus of claim 1 wherein said filter function changes dynamically over a predetermined time period.

35. The apparatus of claim 1 wherein said filter function changes continuously based on a predetermined filter change profile.

36. The apparatus of claim 1, wherein the light dispersive element comprises a diffraction grating.

37. The apparatus of claim 1, wherein the light dispersive element disperses the optical channels of the input light onto the pixellating device to substantially separate the optical channels on the pixellating device.

38. The apparatus of claim 1, wherein the light dispersive element disperses the optical channels of the input light onto the pixellating device to substantially overlap the optical channels on the pixellating device.

39. The apparatus of claim 1, wherein the cross-sectional area of at least one channel of said separated input light is generally circular in shape.

40. The apparatus of claim 1, wherein the cross-sectional area of at least one channel of said separated input light is generally elliptical in shape.

41. The apparatus of claim 1, wherein at least one optical channel of said input light is projected onto at least 50 micro-mirrors of said pixellating device.

42. The apparatus of claim 1, wherein micro-mirrors discretely switch from said first position to said second position.

43. A variable optical source, comprising:
a light dispersive element which receives an optical input signal having various wavelength channels of light, which provides a separated light signal having said wavelength channels spatially distributed by a predetermined amount;
a pixellating device, which receives said separated light, having a two dimensional array of pixels, each of said channels being incident on a plurality of pixels, each of said pixels having a first reflection state and a second reflection state in response to a pixel control signal, and said pixellating device providing a reflected separated light signal indicative of light provided from said first reflection state;
said light dispersive element dispersing the optical channels of the input light onto said pixelating device to substantially overlap the optical channels on said pixellating device; and
a light combining element, which receives said reflected separated light, recombines said reflected separated light, and provides an optical filter output signal indicative of a spectrally filtered optical input signal based on a filter function.

44. The apparatus of claim 1 wherein said pixelating device comprises a micro-mirror device and said pixels comprise micromirrors.

45. The apparatus of claim 1 wherein said filter function is: a band pass filter, a low pass filter, a band reject filter, or a high pass filter.

46. The apparatus of claim 1 wherein said filter function is a predetermined optical loss function.

47. The apparatus of claim 1 wherein said output signal has a substantially flat spectral profile.

48. The apparatus of claim 1 wherein said filter function changes dynamically over a predetermined time period.

49. The apparatus of claim 1 wherein said filter function changes continuously based on a predetermined filter change profile.

50. The apparatus of claim 1, wherein the light dispersive element comprises a diffraction grating.

51. The apparatus of claim 1, wherein the cross-sectional area of at least one channel of said separated input light is generally circular in shape.

52. The apparatus of claim 1, wherein the cross-sectional area of at least one channel of said separated input light is generally elliptical in shape.

53. The apparatus of claim 1, wherein at least one optical channel of said input light is projected onto at least 50 micro-mirrors of said pixellating device.

54. The apparatus of claim 1, wherein micro-mirrors discretely switch from said first position to said second position.

55. A variable optical source, comprising:
a light dispersive element which receives an optical input signal having various wavelength channels of light, which provides a separated light signal having said wavelength channels spatially distributed by a predetermined amount;
a pixellating device, which receives said separated light, having a two dimensional array of pixels, each of said channels being incident on a plurality of pixels, each of said pixels having a first reflection state and a second reflection state in response to a pixel control signal, and said pixellating device providing a reflected separated light signal indicative of light provided from said first reflection state;
a light combining element, which receives said reflected separated light, recombines said reflected separated light, and provides an optical filter output signal indicative of a spectrally filtered optical input signal based on a filter function; and
wherein said pixellating device is oriented such that the optical path length for a given wavelength channel is substantially constant across the projected image on the pixellating device.

56. The apparatus of claim 1 wherein said pixelating device comprises a micro-mirror device and said pixels comprise micromirrors.

57. The apparatus of claim 1 wherein said reflected separated light from said first reflection state reflects light substantially perpendicular to a spectral axis along said pixellating device.

58. The apparatus of claim 1 wherein said filter function is: a band pass filter, a low pass filter, a band reject filter, or a high pass filter.

59. The apparatus of claim 1 wherein said filter function is a predetermined optical loss function.

60. The apparatus of claim 1 wherein said output signal has a substantially flat spectral profile.

61. The apparatus of claim 1 wherein said filter function changes dynamically over a predetermined time period.

62. The apparatus of claim 1 wherein said filter function changes continuously based on a predetermined filter change profile.

63. The apparatus of claim 1, wherein the light dispersive element comprises a diffraction grating.

64. The apparatus of claim 1, wherein the light dispersive element disperses the optical channels of the input light onto the pixellating device to substantially separate the optical channels on the pixellating device.

65. The apparatus of claim 1, wherein the light dispersive element disperses the optical channels of the input light onto the pixellating device to substantially overlap the optical channels on the pixellating device.

66. The apparatus of claim 1, wherein the cross-sectional area of at least one channel of said separated input light is generally circular in shape.

67. The apparatus of claim 1, wherein the cross-sectional area of at least one channel of said separated input light is generally elliptical in shape.

68. The apparatus of claim 1, wherein at least one optical channel of said input light is projected onto at least 50 micro-mirrors of said pixellating device.

69. The apparatus of claim 1, wherein micro-mirrors discretely switch from said first position to said second position.
